(19) United States
(12) Patent Application Publication
(10) Pub. No.: US 2022/0237598 A1
(43) Pub. Date: Jul. 28, 2022

(54) EFFICIENT, ACCURATE, AND SECURE DIGITAL ASSET CONVERSIONS FOR REAL-TIME FUNDING OF MERCHANT TRANSACTIONS

(71) Applicant: Bakkt Marketplace, LLC, Atlanta, GA (US)

(72) Inventors: Nicolas Frederic Cabrera, Atlanta, GA (US); Jeffrey Scott Pittelkau, Montgomery, AL (US); Nikolais Linsteadt, Applegate, CA (US); Joseph Arthur Revnes, Atlanta, GA (US); Brian Daniel Cooper, Marietta, GA (US); William Matthau, Laguna Niguel, CA (US); Christopher Michael Petersen, Lakeway, TX (US); Yamini Bistesh Sagar, Alpharetta, GA (US); Utkarsh Agarwal, Tucson, AZ (US); Tim Kuchlein, Cupertino, CA (US); Bharath Lakshmanan, San Ramon, CA (US); William Andrew Bryant, Alpharetta, GA (US); Stephen Paul Saucier, Atlanta, GA (US); Deepak Kumar, Marietta, GA (US); Anil Jaiswal, Marietta, GA (US); Byungkwon Jeon, Cumming, GA (US); Balaji Devarasetty, Atlanta, GA (US)

(21) Appl. No.: 17/460,799

(22) Filed: Aug. 30, 2021

Related U.S. Application Data
(60) Provisional application No. 63/199,750, filed on Jan. 22, 2021.

(51) Int. Cl. G06Q 20/38; G06Q 20/40; G06Q 20/26

(52) U.S. Cl. CPC G06Q 20/381; G06Q 20/26; G06Q 20/40

(57) ABSTRACT

Various embodiments are directed to processing and executing digital asset conversions for real-time funding of a merchant transaction involving a user. The user may pre-select digital assets to be converted to fiat currency, and a pre-selected digital asset can be internally-custodied or externally-custodied. An example method includes retrieving a first account balance data object for a fiat currency account associated with the user. The method further includes, responsive to determining that a balance of the fiat currency user account does not satisfy a fiat currency unit threshold of a merchant transaction, retrieving a second account balance data object for a digital asset account associated with the user, determining a conversion rate between a digital asset and a fiat currency, and executing a digital asset conversion by closed-loop debiting digital asset units from the digital asset account and crediting fiat currency units to the fiat currency account.

### CROSS-REFERENCE TO RELATED APPLICATIONS

This application claims the benefit of U.S. Provisional Patent Application Ser. No. 63/199,750 filed on Jan. 22, 2021, which is incorporated herein by reference in its entirety, including any figures, tables, drawings, and appendices.

### TECHNOLOGICAL FIELD

Embodiments of the present disclosure generally relate to the management, use, transaction processing, and/or the like of digital assets and related data thereof.

### BACKGROUND

Various embodiments of the present disclosure address technical challenges related to processing and funding merchant transactions involving an end user and improving the efficiency, accuracy, and security of such processing.

### BRIEF SUMMARY

In general, embodiments of the present disclosure provide methods, apparatus, systems, computing devices, computing entities, and/or the like for processing and executing digital asset conversions for real-time funding of a merchant transaction for an end user. In particular, digital assets owned by the end user are converted to a fiat currency such that the end user is in possession of a sufficient number of fiat currency units to complete the merchant transaction, and the merchant transaction is subsequently authorized. In various embodiments, conversion of a digital asset to a fiat currency comprises a debit of digital asset units from a digital asset user account associated with the end user and a credit of fiat currency units to a fiat currency user account associated with the end user. The number of digital asset units debited and the number of fiat currency units credited are determined according to a conversion rate between the digital asset and the fiat currency such that the number of digital asset units debited and the number of fiat currency units credited are substantially similar or equivalent in value.

Various embodiments enable the end user to specify one or more digital assets to be converted when real-time funding of a merchant transaction is necessary (e.g., when the end user possesses insufficient fiat currency units to complete the merchant transaction). Various embodiments of the present disclosure provide an account management system configured to process and execute digital asset conversions for internally-custodied digital assets (e.g., managed by the account management system) and for externally-custodied digital assets (e.g., managed by other systems), and the one or more digital assets specified by the end user may be internally-custodied digital assets and/or externally-custodied digital assets.

Accordingly, various embodiments provide various technical advantages generally relating to the efficiency, accuracy, and security of processing and executing digital asset conversions for real-time funding of merchant transactions. Digital asset conversions are immediately and responsively executed upon determination that funding of a merchant transaction is necessary, and in various instances, the end user is funded with fiat currency units within milliseconds and/or seconds. Accordingly, the merchant transaction is quickly authorized, or in instances in which the end user also does not possess enough digital asset units to convert, the merchant transaction is quickly declined. Immediate and rapid execution of the digital asset conversions are enabled by the end user pre-configuring and pre-selecting digital assets as funding sources, thereby reducing system load and resources used by the end user at the time of the merchant transaction. In various embodiments, digital asset units and fiat currency units are accurately debited and credited with respect to the real-time value of the digital asset. Further, end user data, such as account data for digital asset user accounts and fiat currency user accounts, are efficiently and securely maintained in a centralized manner.

In accordance with one aspect, a computer-implemented method is provided. The method includes receiving an authorization request data object originating from a merchant device. The authorization request data object describes a merchant transaction involving an end user and fiat currency unit threshold. The method further includes retrieving a first account balance data object corresponding to a fiat currency user account associated with the end user, and determining whether a balance of the fiat currency user account satisfies the fiat currency unit threshold of the merchant transaction using the first account balance data object. The method further includes, responsive to determining that the balance of the fiat currency user account does not satisfy the fiat currency unit threshold of the merchant transaction: retrieving a second account balance data object corresponding to a digital asset user account associated with the end user and specific to a digital asset; determining a conversion rate between the digital asset and a fiat currency; executing a digital asset conversion including a closed-loop debit of a number of digital asset units from the digital asset user account and a credit of a number of fiat currency units to the fiat currency user account; updating the first account balance data object according to the execution of the digital asset conversion; and causing transmission of a response data object to the merchant device. The response data object includes one of an authorization or a denial of the merchant transaction based at least in part on the balance of the fiat currency user account resulting from the digital asset conversion and described by the first account balance data object.

In various embodiments, determining the conversion rate between the digital asset and the fiat currency includes causing transmission of a conversion rate API query indicating the digital asset and comprising an identifier token associated with the end user, and receiving a conversion rate API response comprising a conversion rate between the digital asset and the fiat currency. In various embodiments, executing the digital asset conversion includes determining the number of digital asset units for the closed-loop debit based at least in part on the balance of the fiat currency user account, the fiat currency unit threshold of the merchant transaction, and the conversion rate between the digital asset and the fiat currency. In various embodiments, the number of digital asset units for the closed-loop debit is determined further based at least in part on one or more conversion limits associated with the end user and/or the digital asset. In various embodiments, the computer-implemented method further includes determining whether a resulting balance of the fiat currency user account subsequent to executing the digital asset conversion satisfies the fiat currency threshold of the merchant transaction. The computer-implemented method further includes, responsive to determining that the resulting balance does not satisfy the fiat currency threshold of the merchant transaction, executing a second digital asset conversion for a second digital asset including a closed-loop debit from a second digital asset user account associated with the end user and specific to the second digital asset, and a credit of a second number of fiat currency units to the fiat currency user account. In various embodiments, the digital asset is one of a set of digital assets pre-selected by the end user, and each digital asset is associated with a precedence value indicating a priority with which to execute a digital asset conversion for a respective digital asset.

In accordance with another aspect, a system is provided. The system includes one or more memory storage areas and one or more processors. The system is configured for receiving an authorization request data object originating from a merchant device. The authorization request data object describes a merchant transaction involving an end user and fiat currency unit threshold. The system is further configured for retrieving a first account balance data object corresponding to a fiat currency user account associated with the end user, and determining whether a balance of the fiat currency user account satisfies the fiat currency unit threshold of the merchant transaction using the first account balance data object. The system is further configured for, responsive to determining that the balance of the fiat currency user account does not satisfy the fiat currency unit threshold of the merchant transaction: retrieving a second account balance data object corresponding to a digital asset user account associated with the end user and specific to a digital asset; determining a conversion rate between the digital asset and a fiat currency; executing a digital asset conversion including a closed-loop debit of a number of digital asset units from the digital asset user account and a credit of a number of fiat currency units to the fiat currency user account; updating the first account balance data object according to the execution of the digital asset conversion; and causing transmission of a response data object to the merchant device. The response data object includes one of an authorization or a denial of the merchant transaction based at least in part on the balance of the fiat currency user account resulting from the digital asset conversion and described by the first account balance data object.

In various embodiments, determining the conversion rate between the digital asset and the fiat currency includes causing transmission of a conversion rate API query indicating the digital asset and comprising an identifier token associated with the end user, and receiving a conversion rate API response comprising a conversion rate between the digital asset and the fiat currency. In various embodiments, executing the digital asset conversion includes determining the number of digital asset units for the closed-loop debit based at least in part on the balance of the fiat currency user account, the fiat currency unit threshold of the merchant transaction, and the conversion rate between the digital asset and the fiat currency. In various embodiments, the number of digital asset units for the closed-loop debit is determined further based at least in part on one or more conversion limits associated with the end user and/or the digital asset. In various embodiments, the system is further configured for determining whether a resulting balance of the fiat currency user account subsequent to executing the digital asset conversion satisfies the fiat currency threshold of the merchant transaction. The system is further configured for, responsive to determining that the resulting balance does not satisfy the fiat currency threshold of the merchant transaction, executing a second digital asset conversion for a second digital asset including a closed-loop debit from a second digital asset user account associated with the end user and specific to the second digital asset, and a credit of a second number of fiat currency units to the fiat currency user account. In various embodiments, the digital asset is one of a set of digital assets pre-selected by the end user, and each digital asset is associated with a precedence value indicating a priority with which to execute a digital asset conversion for a respective digital asset.

In accordance with yet another aspect, a computer program product is provided. The computer program product includes at least one non-transitory computer-readable storage medium having computer-readable program code portions stored therein. The computer-readable program code portions include executable portions configured for receiving an authorization request data object originating from a merchant device. The authorization request data object describes a merchant transaction involving an end user and fiat currency unit threshold. The computer-readable program code portions include executable portions further configured for retrieving a first account balance data object corresponding to a fiat currency user account associated with the end user, and determining whether a balance of the fiat currency user account satisfies the fiat currency unit threshold of the merchant transaction using the first account balance data object. The computer-readable program code portions include executable portions further configured for, responsive to determining that the balance of the fiat currency user account does not satisfy the fiat currency unit threshold of the merchant transaction: retrieving a second account balance data object corresponding to a digital asset user account associated with the end user and specific to a digital asset; determining a conversion rate between the digital asset and a fiat currency; executing a digital asset conversion including a closed-loop debit of a number of digital asset units from the digital asset user account and a credit of a number of fiat currency units to the fiat currency user account; updating the first account balance data object according to the execution of the digital asset conversion; and causing transmission of a response data object to the merchant device. The response data object includes one of an authorization or a denial of the merchant transaction based at least in part on the balance of the fiat currency user account resulting from the digital asset conversion and described by the first account balance data object.

In various embodiments, determining the conversion rate between the digital asset and the fiat currency includes causing transmission of a conversion rate API query indicating the digital asset and comprising an identifier token associated with the end user, and receiving a conversion rate API response comprising a conversion rate between the digital asset and the fiat currency. In various embodiments, executing the digital asset conversion includes determining the number of digital asset units for the closed-loop debit based at least in part on the balance of the fiat currency user account, the fiat currency unit threshold of the merchant transaction, and the conversion rate between the digital asset and the fiat currency. In various embodiments, the number of digital asset units for the closed-loop debit is determined further based at least in part on one or more conversion limits associated with the end user and/or the digital asset. In various embodiments, the computer-readable program code portions include executable portions further configured for determining whether a resulting balance of the fiat currency user account subsequent to executing the digital asset conversion satisfies the fiat currency threshold of the merchant transaction. The computer-readable program code portions include executable portions further configured for, responsive to determining that the resulting balance does not satisfy the fiat currency threshold of the merchant transaction, executing a second digital asset conversion for a second digital asset including a closed-loop debit from a second digital asset user account associated with the end user and specific to the second digital asset, and a credit of a second number of fiat currency units to the fiat currency user account. In various embodiments, the digital asset is one of a set of digital assets pre-selected by the end user, and each digital asset is associated with a precedence value indicating a priority with which to execute a digital asset conversion for a respective digital asset.

### BRIEF DESCRIPTION OF THE DRAWING(S)

Having thus described the present disclosure in general terms, reference will now be made to the accompanying drawings, which are not necessarily drawn to scale, and wherein:

FIG. 1 is an exemplary diagram of a system architecture, in accordance with various embodiments of the present disclosure;

FIG. 2 is an exemplary schematic of an account management system, in accordance with various embodiments of the present disclosure;

FIG. 3 is an exemplary schematic of a client device, in accordance with various embodiments of the present disclosure;

FIGS. 4A-C provide flowchart diagrams of an example process for processing and executing digital asset conversions for real-time funding of a merchant transaction, in accordance with various embodiments of the present disclosure;

FIG. 5 provides a flowchart diagram of an example process enabling an end user to configure the processing and execution of digital asset conversions for real-time funding of a merchant transaction, in accordance with various embodiments of the present disclosure; and

FIGS. 6-9 provide example user interfaces for the processing and the execution of digital asset conversions for real-time funding of a merchant transaction.

### DETAILED DESCRIPTION OF SOME EXAMPLE EMBODIMENTS

Various embodiments of the present disclosure now will be described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” (also designated as “/”) is used herein in both the alternative and conjunctive sense, unless otherwise indicated. The terms “illustrative” and “exemplary” are used to be examples with no indication of quality level. Like numbers refer to like elements throughout.

### I. General Overview and Technical Advantages

Various embodiments of the present disclosure are generally directed to processing and executing digital asset conversions for real-time funding of a merchant transaction for an end user. In various embodiments, one or more digital asset conversions are executed according to a determination that a balance of a fiat currency user account associated with the end user is insufficient for the merchant transaction, thereby necessitating funding of the merchant transaction. Digital asset conversions are executed in order to credit the end user with a sufficient number of fiat currency units for the merchant transaction, and in various embodiments, the merchant transaction is subsequently approved. If the end user does not own a sufficient number of fiat currency units nor a sufficient number of digital asset units that may be converted to fiat currency units, then the merchant transaction may be declined.

To allow for efficient, rapid, and real-time execution of digital asset conversions to fund the merchant transaction, various embodiments enable pre-configuration or pre-selection of digital assets to use for the digital asset conversions (e.g., to convert to fiat currency), and each digital asset may be associated with a precedence value. Digital asset conversions are then executed according to the precedence values associated with the pre-configured or pre-selected digital assets. For example, the digital asset with the highest precedence value is converted to fiat currency first, and the digital asset with the next highest precedence value is only converted if the resulting balance of the fiat currency user account is still insufficient. Thus, multiple digital assets are sequentially converted to fiat currency until the end user possesses a sufficient number of fiat currency units for the merchant transaction.

The pre-configured or pre-selected digital assets may be internally-custodied and/or externally-custodied digital assets. For internally-custodied digital assets, account data corresponding to digital asset user accounts associated with the end user and specific to the internally-custodied digital assets are retrieved (e.g., from memory, from an internal database), and closed-loop debits of the internally-custodied digital assets are automatically executed according to their pre-configuration or pre-selection. For externally-custodied digital assets, account data corresponding to digital asset user accounts associated with the end user and specific to the externally-custodied digital assets are received from external systems based at least in part on generating and transmitting account queries. Externally-custodied digital assets are then automatically debited via generation and transmission of conversion execution API queries according to their pre-configuration or pre-selection. Accordingly, various embodiments advantageously reduce the number of merchant transactions that are declined due to the automatic conversion of digital assets to fiat currency to fund said merchant transactions. Overall system load used in handling merchant transactions at the time of the transactions is also reduced.

In processing and executing digital asset conversions for real-time funding of merchant transactions, various embodiments provide solutions to technical challenges. With regard to the execution of a digital asset conversion involving an internally-custodied digital asset, closed-loop transactions to debit digital asset units are executed to enable faster processing of the digital asset conversion within milliseconds and/or seconds. Closed-loop transactions within a closed-loop environment for the internally-custodied digital asset involve and are managed by the central operating or managing entity of the closed-loop environment, and such centralization ensures efficient processing (e.g., by obviating external communication for processing and validation), improved security (e.g., decreasing the number of involved parties, such as for validation), and improved accuracy (e.g., decreasing the number of errors that may arise from external communication). For example, closed-loop transactions within closed-loop environments for cryptoassets and cryptocurrency digital assets are off-chain transactions that enable fast and efficient processing compared to on-chain transactions that inherently involve publication of transaction information and validation of the on-chain transaction by a large number of parties (e.g., occurring on a scale of hours and/or days) and compromising the privacy and confidentiality of the parties involved. Thus, execution of digital asset conversions for an internally-custodied digital asset via closed-loop transactions (e.g., off-chain transactions) within a closed-loop environment by a central operating or managing entity provides various technical advantages.

For externally-custodied digital assets, efficient communication with external systems to cause the debit of units of an externally custodied digital asset is performed in various embodiments of the present disclosure. For example, a conversion execution API query that both identifies a digital asset user account and defines a number of digital asset units to debit in a structured manner is generated and transmitted to an external system that manages the externally-custodied digital asset and corresponding digital asset user accounts. Such conversion execution API queries are lightweight and promptly communicated, extending the efficiency of digital asset transfers in various embodiments.

In various embodiments, the lightweight nature of transfer execution API queries and other communications with external systems is due in part to identifier tokens configured to identify end users. Specifically, each end user is associated with an identifier token, and the identifier token identifies one or more digital asset user accounts associated with (e.g., owned by) the end user. In doing so, the identifier token is federated, global, universal, and/or the like, as the identifier token identifies digital asset user accounts that may be managed by different external systems. Accordingly, the identifier token is configured to be recognizable and processed by different external systems. This configuration and use of identifier tokens conserves computing and processing resources that would be otherwise used to individually identify each digital asset user account for an end user according to different processing or identification protocols for different external systems.

Further, various embodiments are configured to accurately execute digital asset conversions based at least in part on a current and real-time determination of conversion rates between digital assets and the fiat currency. That is, a conversion rate between a digital asset and the fiat currency is determined just prior to execution of a digital asset conversion. In various embodiments, a conversion rate is determined based at least in part on generating and transmitting a conversion rate API query and receiving a conversion rate API response comprising the conversion rate. Such an implementation involving an API results in a conversion rate being determined efficiently and rapidly, such that the conversion rate remains accurate with respect to the value or worth of a digital asset when a digital asset conversion is subsequently executed. Efficient determination of a conversion rate proves advantageous for accurate valuation of particularly volatile digital assets. In various embodiments, the conversion rate that accurately reflects the current and real-time value or worth of a digital asset is used to determine an accurate number of digital asset units to debit and an accurate number of fiat currency units.

### II. Exemplary Definitions

The term “digital asset” may generally refer to any data entity that is perceived to hold value (e.g., transactional value). Examples of digital assets include a cryptoasset or cryptocurrency, a liability digital asset (e.g., vendor/merchant loyalty or reward points), an in-game asset or ecosystem-specific asset (e.g., a video game cosmetic item), and/or the like. A digital asset unit of a digital asset may be understood as a quantification or basis of the digital asset, such as an individual Bitcoin (BTC), one vender/merchant loyalty point, and/or the like, and for various digital assets, a total supply of the digital asset includes multiple digital asset units (e.g., number of digital asset units in circulation). A digital asset may be quantified, managed, transacted, converted, exchanged, transferred, and/or the like based at least in part on full and/or fractional units. For example, a digital asset transaction may involve one BTC unit, two BTC units, one-hundred BTC units, and/or the like (full units), while another digital asset transaction may involve 0.4 BTC units, 1.5 BTC units, 0.0150 BTC units, and/or the like (fractional units). A digital asset may also be a single-unit digital asset, such as a non-fungible token (NFT) or an ownership token, for which only one digital asset exists in circulation. The value held by a digital asset and an associated right to use the digital asset enable the digital asset to be exchanged for fiat currency, used for purchasing goods and services in some instances, and/or the like. A digital asset may be a strictly digital construct and may not exist in a physical state.

The term “fiat currency” may refer to a currency that is not necessarily related to or backed by a physical commodity. A fiat currency may be centrally managed and distributed by a central entity. Examples of fiat currencies may include U.S. dollars (USD, $), European Union (EU) euros, Chinese yen, English pounds, and/or the like that are managed and distributed by respective governments. The central entity managing a fiat currency may have the authority to increase and/or decrease the supply of a fiat currency. A fiat currency has an inherent and accepted transactional value, which may be based at least in part on a relationship between the supply of the fiat currency and the demand of the fiat currency. Thus, the value of fiat currency is managed by a central entity. The value of fiat currency may be used as a reference for evaluating a variable value of a digital asset. A fiat currency may be quantified by fiat currency units. For example, one unit of the U.S. dollar fiat currency may be understood as a single dollar. Value of various digital assets and other purchased goods or services may be described by a number of fiat currency units.

The term “digital asset conversion” may generally refer to an event, an act, and/or the like in which an end user obtains fiat currency units at the cost of digital asset units. In various instances, the end user is associated with a fiat currency user account and a digital asset user account specific to a digital asset, and a digital asset conversion results in an increase in the balance of the fiat currency user account and a decrease in the balance of the digital asset user account. Thus, execution of a digital asset conversion generally involves a debit of a number of digital asset units from the digital asset user account and a credit of a number of fiat currency units to the fiat currency user account. The number of digital asset units debited and the number of fiat currency units are substantially equivalent in value or worth. Thus, the end user converts the number of digital asset units to the number of fiat currency units.

The term “conversion rate” may refer to a data entity describing a relative value (e.g., a transactional value) or worth of a digital asset. In various instances, a conversion rate may describe the value of a digital asset with respect to a fiat currency. For example, a conversion rate for a liability digital asset may indicate that one unit of the liability digital asset (e.g., one reward point) is worth or equal in value to ten fiat currency units (e.g., USD $10). A conversion rate may describe a full and/or fractional value of a digital asset. A conversion rate for a digital asset may be variable over time. As such, a conversion rate may be historical, current, or indicative, and different conversion rates for a digital asset may be associated with different time points or periods. Various embodiments of the present disclosure involve real-time retrieval and determination of conversion rates, such that an accurate and current value of the digital asset is referenced in digital asset conversions for real-time funding of merchant transactions. In various instances, a conversion rate of a digital asset is individualized and/or cohort-based, such that different end users and/or cohorts (e.g., behavioral cohorts) are subject to different conversions rates of a digital asset. A conversion rate specific to a particular end user and/or a particular cohort (e.g., a particular behavioral cohort) may be determined using predictive models, optimization models, machine learning models, and/or the like, in some instances. For example, a conversion rate for an end user is determined based at least in part on behavioral data associated with the end user.

The terms “conversion rate API query” and “conversion rate API response” may each refer to data entities relating to determining a conversion rate for a digital asset. A conversion rate API query represents a request for a conversion rate for a digital asset and accordingly may identify the digital asset. The conversion rate API query may further indicate a particular fiat currency as a basis for the requested conversion rate. For example, a conversion rate API query may request a conversion rate with respect to U.S. dollars or a conversion rate with respect to E.U. euros. As previously discussed, conversion rates may be individualized and/or cohort-based, and as such, a conversion rate API query may identify one or more end users for whom the requested conversion rate is applicable. For example, the conversion rate API query comprises an identifier token and/or a behavioral data object for an end user. A conversion rate API response comprising a conversion rate is provided in response to a conversion rate API query.

The term “identifier token” may refer to a data entity associated with an end user and configured to identify the end user for one or more systems. In various embodiments, an identifier token is associated with each of a plurality of end users. An identifier token is configured to describe various user accounts associated with the end user, and as such may describe an ownership portfolio of the end user. For example, the identifier token may reference one or more fiat currency user accounts, one or more digital asset user accounts each specific to a digital asset, and or the like associated with the end user. In various embodiments, the identifier token is federated, global, universal, and/or the like, such that the end user may be identified by one or more systems when provided with an identifier token. For example, one identifier token is used to identify, locate, retrieve, reference, and/or the like digital asset user accounts specific to different digital assets and managed by different systems. In various embodiments, the identifier token uses single-sign-on (SSO) authentication techniques to identify the end user. The identifier token may comprise additional information including end user identifying information (e.g., name, birthdate, Social Security Number), a globally unique identifier (GUID), a universally unique identifier (UIUD), a hash or cryptographic value of user information or credentials, and/or the like. In various embodiments, the identifier token is a data object, a data structure, a matrix, an array, a vector, and/or the like.

The term “behavioral cohort” may refer to a data entity describing and/or identifying a plurality of end users that are each similar in some aspect to others of the plurality. A behavioral cohort may comprise various information related to each end user (e.g., name, birthdate, Social Security number, permanent address, account identifiers). Example common aspects among end users of a behavioral cohort include demographic information (e.g., age, location) and/or other information associated with the end user, digital asset user account statuses (e.g., account tier or level, account age, account type), merchant transactional history, digital asset transactional history (e.g., historical transactions, redemptions, conversions, exchanges, transfers), historical and/or predicted propensity for digital asset transactional activity (e.g., initiating or requesting a digital asset transfer, conversion, exchange, redemption, and/or the like), and/or the like. For example, an example behavioral cohort is comprised of end users who have frequently purchase units of Bitcoin. As another example, an example behavioral cohort is comprised of end users who each have had less than a threshold amount of merchant transaction activity within the past two weeks. As yet another example, an example behavioral cohort is comprised of end users who reside near a merchant. Thus, a conversion behavior cohort is comprised of end users based at least in part on an individual aspect or any combination of aspects. In various embodiments, the behavioral cohort is a data object, a data structure, a matrix, an array, a vector, a graph, and/or the like.

The term “behavioral data object” may refer to a data entity configured to describe behavioral data of a particular end user and/or behavioral data common among or aggregated from a behavioral cohort. Example behavioral data includes digital asset user account status (e.g., account tier or level, account age, account type), merchant transactional history, digital asset transactional history (e.g., historical transactions, redemptions, conversions, exchanges, transfers), historical and/or predicted propensity for digital asset transactional activity (e.g., initiating a digital asset transfer, requesting a digital asset transfer, converting a digital asset to fiat currency, converting a digital asset to another digital asset), and/or the like. For example, behavioral data includes conversion rates at which the end user and/or the behavioral cohort has converted a digital asset. In various embodiments, a behavioral data object comprises predictive behavioral data, such as data generated using a predictive model, optimization model, machine learning model, and/or the like. In various embodiments, the behavioral cohort is a data object, a data structure, a matrix, an array, a vector, a graph, and/or the like.

The term “internally-custodied digital asset” may refer to a digital asset that is managed by a system configured to process and execute digital asset conversions for real-time funding of merchant transactions according to various embodiments of the present disclosure. Specifically, management of a digital asset may involve issuance of digital asset units, generation and management of digital asset user accounts specific to the digital asset (e.g., having balances of units of the digital asset), redemption of digital asset units for goods and services, and/or the like. Thus, in various embodiments of the present disclosure, a system configured to process and execute digital asset conversions for real-time funding of merchant transactions is also configured to manage and/or is associated with an entity responsible for managing one or more internally-custodied digital assets. In various instances, an internally-custodied digital asset is managed and distributed within a closed-loop environment or ecosystem by said system, according to various embodiments of the present disclosure.

The term “closed-loop environment” may describe an environment, ecosystem, system, platform, economy, and/or the like within which a total circulation supply of a digital asset is distributed among parties of the closed-loop environment. Accordingly, parties of the closed-loop environment may transact with the digital asset of the closed-loop environment (e.g., purchase or sell digital asset units) with other parties within the closed-loop environment, while the total circulation supply of the digital asset remains theoretically fixed. Digital asset transactions between different parties of the closed-loop environment (e.g., closed-loop transactions) may then represent a re-distribution of digital asset units among the parties of the closed-loop environment. A closed-loop environment is managed by a central operating or managing entity that may increase or decrease the total circulation supply of the digital asset via transactions with external systems (e.g., open-loop transactions), may oversee and/or execute debits and credits of digital assets within the closed-loop environment (e.g., closed-loop transactions), and/or the like. Meanwhile, parties of the closed-loop environment may be restricted from transacting with the digital asset (e.g., purchasing, selling) externally from the closed-loop environment.

The term “closed-loop transaction” may describe a movement, a redistribution, an exchange, and/or the like of digital assets within a closed-loop environment. In general, a closed-loop transaction may be a debit of digital asset units from a digital asset user account in the closed-loop environment or a credit of digital asset units to a digital asset user account in the closed-loop environment. A closed-loop transaction that is a debit of digital asset units from a digital asset user account involves transferring digital asset units from the digital asset user account to a central operating account (e.g., a reserve) of the closed-loop environment, while a closed-loop transaction that is a credit of digital asset units to a digital asset user account involves transferring digital asset units from the central operating account to the digital asset user account. A closed-loop transaction is bounded by the closed-loop environment and does not involve parties external to the closed-loop environment. An example of a closed-loop transaction is an off-chain transaction of a cryptoasset or a cryptocurrency digital asset.

The term “externally-custodied digital asset” may refer to a digital asset that is managed by an external system different than the system via which end users request digital asset transfers. In contrast to internally-custodied digital assets, externally-custodied digital assets may not be managed by the system configured to process and execute digital asset conversions for real-time funding of merchant transactions according to various embodiments of the present disclosure. Transactions for an externally-custodied digital asset may be executed via communication with the external system managing the externally-custodied digital asset, such as via an application programming interface of the external system.

The term “conversion execution API query” may refer to a data entity configured to cause execution of a digital asset transfer at least in part. Specifically, a conversion execution API query may be configured to cause a number of digital asset units to be debited from a digital asset user account. In doing so, a transfer execution API query defines a number of digital asset units to debit or to credit and identifies a digital asset user account for the debit or for the credit. In various embodiments, a confirmation of execution is provided via an API response in response to a transfer execution API query. A conversion execution API query is generated and transmitted to an external system to cause the debit of an externally-custodied digital asset managed by the external system.

The term “on-chain transaction” may describe a decentralized transaction for a digital asset that is executed and recorded on a distributed ledger (e.g., a blockchain). On-chain transactions are particularly relevant to cryptoassets, cryptocurrencies, and/or other digital assets managed in a decentralized manner. In various examples, on-chain transactions are executed by committing an on-chain transaction record data object to a distributed ledger. By way of decentralization, the on-chain transaction is processed (e.g., verified) by each participating party of the distributed ledger.

The term “on-chain transaction record data object” may refer to a data entity configured to describe an on-chain transaction. An on-chain transaction record data object is committed to a distributed ledger for processing (e.g., authentication, verification, validation, acceptance) of the on-chain transaction. An on-chain transaction record data object is configured to describe at least a number of digital asset units of the on-chain transaction, the nature of the on-chain transaction (e.g., purchase of digital asset units, sale of digital asset units), the time of transaction, the sender of the digital asset units, the recipient of the digital asset units, and/or the like. In various examples, an on-chain transaction record data object identifies the sender and recipient via cryptographic keys and/or key references associated with each of the sender and recipient (e.g., a Bitcoin public key). In various examples, an on-chain transaction record data object comprises one or more cryptographic and/or hash values enabling the authenticity and security of the on-chain transaction record data object to be publicly verified.

The term “off-chain transaction” may describe a transaction of a digital asset not recorded on a distributed ledger (e.g., a blockchain). As such, the off-chain transaction may be processed, agreed upon, verified, and/or the like by entities involved in the off-chain transaction, but the off-chain transaction may be unknown to participants of the distributed ledger who are not involved in the off-chain transaction. An off-chain transaction may rely on external validation methods, as an off-chain transaction is not recorded on a distributed ledger and may not be verified or validated based at least in part on distributed ledger public key values and/or distributed ledger private key values. In some aspects, an off-chain transaction is an example of a closed-loop transaction in a closed-loop environment for a cryptoasset or a cryptocurrency digital asset.

The term “off-chain transaction record data object” may refer to a data entity configured to describe an off-chain transaction. An off-chain transaction record data object is generated and primarily relevant to entities involved in the off-chain transaction. In various instances, an off-chain transaction record data object is not committed to a distributed ledger. An off-chain transaction record data object is configured to describe at least a number of digital asset units of the off-chain transaction, the nature of the off-chain transaction (e.g., purchase of digital asset units, sale of digital asset units), the time of transaction, the sender of digital asset units, the recipient of the digital asset units, and/or the like. As the off-chain transaction record data object serves to record the off-chain transaction for entities involved in the off-chain transaction, the off-chain transaction record data object identifies the sender and/or the recipient via internal identifiers recognized by the entities involved in the off-chain transaction. Thus, in some embodiments, the off-chain transaction record data object does not include cryptographic keys and/or key references configured to identify entities within a distributed ledger.

The term “fiat currency user account” may refer to a data entity configured to describe ownership of a number of fiat currency units. A fiat currency user account is associated with an end user and is specific to a particular fiat currency (e.g., USD). Thus, a fiat currency user account describes ownership of the fiat currency by the end user, and precisely how many units of the fiat currency are owned by the end user. A fiat currency user account may describe liabilities or expenditures of the fiat currency for the end user (e.g., decreases in owned number of digital asset units, merchant transactions), income of the digital asset (e.g., increases in owned number of digital asset units), and/or the like, and may describe such via debit and credit entries.

The term “digital asset user account” may refer to a data entity configured to describe ownership of a number of digital asset units. A digital asset user account is associated with an end user and is specific to a digital asset. Thus, a digital asset user account describes ownership of the digital asset by the end user, such as how many units of the digital asset are owned by the end user. Specifically, a digital asset user account describes liabilities or expenditures of the digital asset for the end user (e.g., decreases in owned number of digital asset units), income of the digital asset (e.g., increases in owned number of digital asset units), and/or the like, and may describe such via debit and credit entries.

The term “account balance data object” may refer to a data entity configured to describe a fiat currency user account or a digital asset user account. In particular, an account balance data object comprises information including a current balance of fiat currency units or digital asset units, various identifiers for the fiat currency user account or the digital asset user account (e.g., account number, routing address, cryptographic keys and/or key references), end user information (e.g., demographics), transactional history (e.g., chronological recording of individual debits and credits, historical merchant transactions), and/or the like. An account balance data object may be a data structure, a matrix, an array, a graph, a vector, embeddings, a dataset, and/or the like. An entity managing a digital asset may be responsible for managing account balance data objects corresponding to digital asset user accounts specific to the digital asset. For example, an external system associated with an externally-custodied digital asset generates, stores, updates, access, and/or the like account balance data objects corresponding to digital asset user accounts specific to the externally-custodied digital asset. Likewise, for example, a system configured for processing and executing digital asset conversions for real-time funding of merchant transactions in accordance with the present disclosure and configured for managing an internally-custodied digital asset is further configured to generate, store, update, access, and/or the like account balance data objects corresponding to digital asset user accounts specific to the internally-custodied digital asset.

The term “account query” may refer to a data entity representing a request for information associated with a digital asset user account. For example, an account query is transmitted to a system to cause the system to respond with information associated with a digital asset user account. The account query may be responded to with an account balance data object associated with the digital asset user account and/or a response comprising the account balance data object. The account query may specifically comprise an identifier token configured to identify the end user associated with the digital asset user account. The account query may be an API request, call, query, and/or the like.

The term “authorization request data object” may refer to a data entity configured to describe a merchant transaction involving an end user and a request to authorization (or decline) the merchant transaction. Accordingly, the authorization request data object may be provided to a system having authority to manage fiat currency owned by the end user. The authorization request data object describes a merchant transaction by at least identifying the end user, defining the number of fiat currency units that should be debited from the end user for the merchant transaction, identifying the merchant, describing the time and/or location of the merchant transaction, and/or the like. In some instances, the authorization request data object is generated by a merchant device (e.g., a point-of-sale device).

The term “authorization response data object” may refer to a data entity configured to indicate an authorization, an approval, and/or the like of a merchant transaction. The authorization response data object may be transmitted to a merchant device in response to receiving an authorization request data object. The authorization response data object is generated and transmitted to a merchant device responsive to a determination that the end user possesses a sufficient number of fiat currency units to complete the merchant transaction (at least a portion of which may have been credited as a result of one or more digital asset conversions).

The term “denial response data object” may refer to a data entity configured to indicate a rejection, a declining of, and/or the like a merchant transaction. The denial response data object may be transmitted to a merchant device in response to receiving an authorization request data object. The denial response data object is generated and transmitted to a merchant device responsive to a determination that the end user does not possess a sufficient number of fiat currency units to complete the merchant transaction, nor does the end user possess a sufficient number of units of one or more digital assets that may be converted to result in a sufficient number of fiat currency units.

### III. Computer Program Products, Methods, and Computing Entities

Embodiments of the present disclosure may be implemented in various ways, including computer program products that comprise articles of manufacture. Such computer program products may include one or more software components including, for example, software objects, methods, data structures, or the like. A software component may be coded in any of a variety of programming languages. An illustrative programming language may be a lower-level programming language, such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of a data structure, apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### IV. Exemplary System Architecture

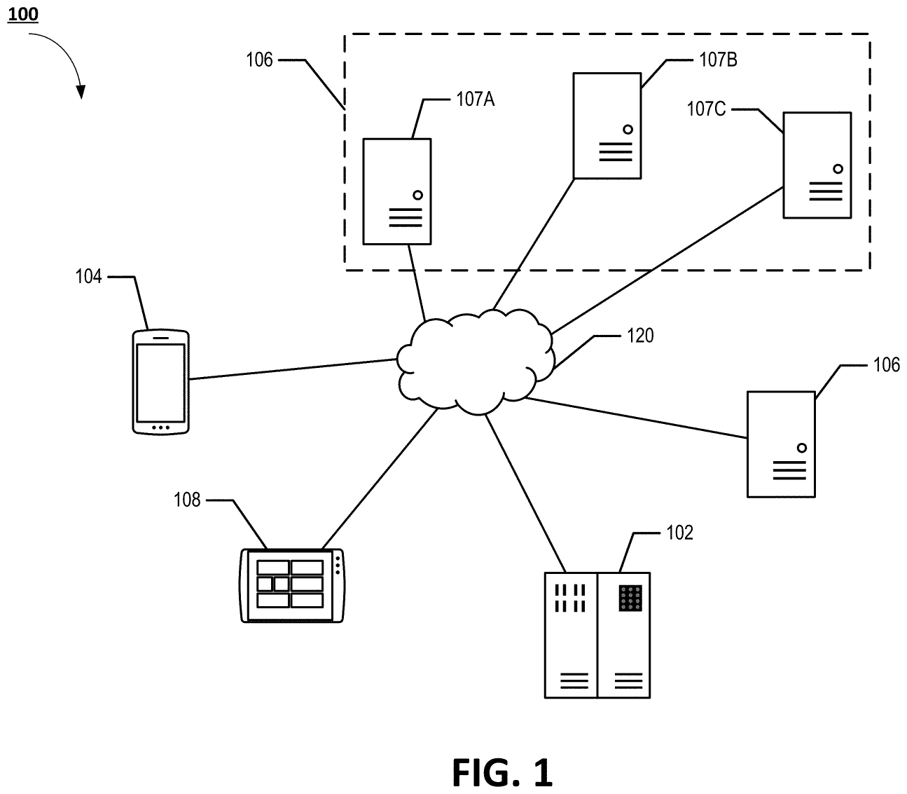

FIG. 1 provides an illustration of an architecture 100 that can be used in conjunction with various embodiments of the present disclosure. As shown in FIG. 1, the architecture 100 may comprise one or more account management systems 102, one or more client devices 104, one or more digital asset exchange systems 106, one or more merchant devices 108, one or more networks 120, and/or the like. In various embodiments, an account management system 102 is configured to process and execute digital asset conversions for real-time funding of merchant transactions involving end users associated with client devices 104. A merchant transaction involves an end user purchasing goods or services from a merchant associated with a merchant device 108, and the end user purchases said goods or services using a payment method associated with the account management system 102, such as a debit card issued and managed by the account management system 102. Accordingly, the merchant device 108 is configured to communicate with the account management system 102 to request authorization or approval of the merchant transaction involving the end user.

Thus, the account management system 102 is configured to communicate with a plurality of merchant devices 108 and may further communicate with a plurality of client devices 104 associated with end users. For example, an end user may indicate to the account management system 102 via an associated client device 104 of one or more digital assets to convert to fiat currency in instances in which the end user possesses an insufficient number of digital asset units to complete a merchant transaction. The account management system 102 may further communicate the execution of one or more digital asset conversions for the real-time funding of a merchant transaction to the end user via the associated client device 104.

In executing one or more digital asset conversions for the real-time funding of a merchant transaction, the account management system 102 may communicate with one or more digital asset exchange systems 106. In various embodiments, the account management system 102 requests and receives a conversion rate for a digital asset from a digital asset exchange system 106 associated with the digital asset. In various instances involving an externally-custodied digital asset, the account management system 102 causes the debit of units of the externally-custodied digital asset by generating and transmitting a conversion execution API query to a digital asset exchange system 106 associated with the externally-custodied digital asset. That is, the account management system 102 communicates with one or more digital asset exchange systems 106 that are external systems responsible for managing externally-custodied digital assets and digital asset user accounts specific to the externally-custodied digital assets.

As shown in FIG. 1, a digital asset exchange system 106 may be and/or comprise a distributed ledger computing platform comprising a plurality of node computing entities 107 (e.g., 107A, 107B, 107C). For example, in an example embodiment, a digital asset exchange system 106 comprises a plurality of node computing entities 107 in communication with one another via a network 120 and each storing copies of a distributed ledger (e.g., a blockchain) for a digital asset (e.g., a cryptocurrency digital asset). Although not explicitly illustrated, the account management system 102 may be a node computing entity 107 of a digital asset exchange system 106, accordingly storing a copy of a distributed ledger for a digital asset and enabled to transact with the digital asset via the distributed ledger. Each node computing entity 107 may be configured to commit and retrieve portions of the distributed ledger (e.g., distributed ledger entries, records, blocks, and/or the like). A node computing entity 107 may be a full node computing entity that stores the entirety of a distributed ledger (e.g., a blockchain), a mining node computing entity that maintains the distributed ledger (e.g., a blockchain) by publishing updated records, entries, blocks and/or the like while also storing the entirety of the distributed ledger, a lightweight node computing entity that does not store the entirety of the distributed ledger (e.g., a blockchain), and/or the like. Various node computing entities 107 may be configured for providing events, consensus requests, and/or the like; performing consensus processing; storing a copy of a distributed ledger; and/or the like.

Each of the components of the architecture 100 may be in electronic communication with, for example, one another over the same or different wireless or wired networks 120 including, for example, a wired or wireless Personal Area Network (PAN), Local Area Network (LAN), Metropolitan Area Network (MAN), Wide Area Network (WAN), or the like. In some embodiments, the plurality of node computing entities 107 of a digital asset exchange system 106 may be in electronic communication with one another over a different wireless or wired network 120 than the account management system 102 and/or the client device 104. While FIG. 1 illustrates certain systems as separate, standalone entities, the various embodiments are not limited to this particular architecture.

a. Exemplary Account Management System

In an example embodiment, an account management system 102 may be a computing entity configured for processing and executing digital asset conversions for real-time funding of merchant transactions involving various end users of a plurality of client devices 104. Generally, the account management system 102 is configured to execute digital asset conversions for internally-custodied digital assets (e.g., managed in a closed-loop environment by the account management system 102) and for externally-custodied digital assets (e.g., managed by a digital asset exchange system 106). In various embodiments, the account management system 102 is configured to execute digital asset conversions to the extent that an end user possesses a sufficient number of fiat currency units for a merchant transaction in the event that the end user initially possess an insufficient number of fiat currency units for the merchant transaction. The account management system 102 may be configured to execute digital asset conversions for multiple digital assets sequentially according to precedence values associated with each digital asset until the end user possesses the sufficient number of fiat currency units.

The account management system 102 is configured to automatically and in real-time execute the digital asset conversions such that the end user is in possession of the sufficient number of fiat currency units within a short and efficient time period, thereby allowing the merchant transaction to be authorized and processed. To do so, the account management system 102 is configured to access a pre-configured or pre-selected set of digital assets that the end user has designated as funding sources for fiat currency. In executing the digital asset conversions, the account management system 102 is configured to access other user-specific data as well as account-specific data. Specifically, the account management system 102 is configured to maintain and update account balance data objects for digital asset user accounts and fiat currency user accounts that are both associated with an end user.

In various embodiments, the account management system 102 is configured to manage and maintain one or more closed-loop environments for one or more internally-custodied digital assets, and in doing so, execute various closed-loop transactions (e.g., closed-loop debits, closed-loop credits). The account management system 102 and/or the entity associated with the account management system 102 controls a central operating account or a reserve for a closed-loop environment for an internally-custodied digital asset. The account management system 102 is also configured to cause the debit and the credit of units of externally-custodied digital assets based at least in part on generating and transmitting conversion execution API queries to various digital asset exchange systems 106 associated with the externally-custodied digital assets.

The account management system 102 is configured to manage concurrent communications with a plurality of merchant devices 108, a plurality of client devices 104 associated with end users, a plurality of digital asset exchange systems 106, and/or the like at substantially the same time. In various embodiments, the account management system 102 stores and/or has access to a plurality of account balance data objects, which each indicate a historical account activity of a corresponding user account (e.g., a fiat currency user account, a digital asset user account). As such, the account management system 102 maintains a record of a plurality of merchant transactions, a plurality of digital asset conversions, and/or the like, and is configured to search and identify specific transactions and/or conversions within the plurality of account balance data objects.

In various embodiments, an account management system 102 may be associated with and operated by one or more various entities to process and execute digital asset conversions for real-time funding of merchant transactions and to authorize or decline said merchant transactions. In an example embodiment, the account management system 102 is operated by an entity (e.g., a banking institution) issuing a payment means (e.g., a payment card) to an end user and is configured to authorize or decline merchant transactions in which the end user has used the payment means. Generally, an account management system 102 may be operated by banking institution entities, digital asset exchange entities, stock exchange entities, trading platform entities, and/or the like. In various embodiments, an account management system 102 may be operated by a single such entity, while in other embodiments, an account management system 102 may host and/or be operated by multiple such entities, each managing digital asset conversions for various client devices 104.

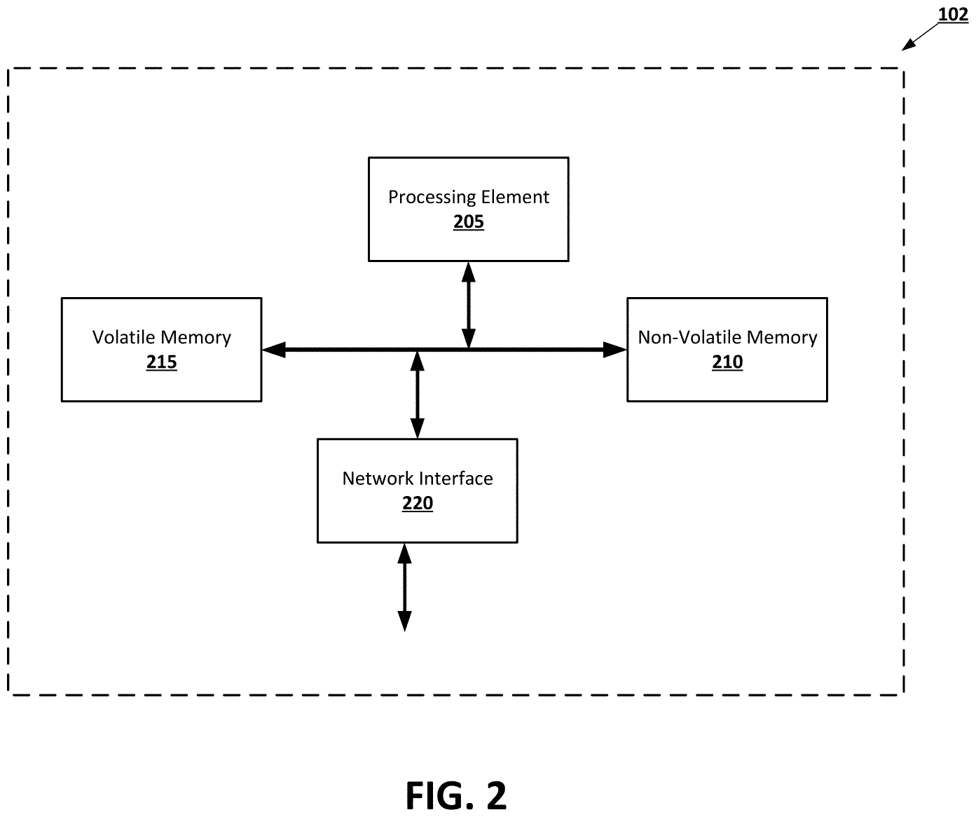

FIG. 2 illustrates a schematic of an example account management system 102, according to one embodiment of the present disclosure. As shown in FIG. 2, in one embodiment, the account management system 102 may include, or be in communication with, one or more processing elements 205 (also referred to as processors, processing circuitry, and/or similar terms used herein interchangeably) that communicate with other elements within the account management system 102 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In one embodiment, the account management system 102 may further include, or be in communication with, non-volatile media (also referred to as non-volatile storage, memory, memory storage, memory circuitry and/or similar terms used herein interchangeably). In one embodiment, the non-volatile storage or memory may include one or more non-volatile storage or memory media 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile storage or memory media 210 may store databases, database instances, database management systems, data, applications, programs, program modules, scripts, source code, object code, byte code, compiled code, interpreted code, machine code, executable instructions, and/or the like. The terms database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In one embodiment, the account management system 102 may further include, or be in communication with, volatile media (also referred to as volatile storage, memory, memory storage, memory circuitry and/or similar terms used herein interchangeably). In one embodiment, the volatile storage or memory may also include one or more volatile storage or memory media 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media 215 may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the step/operation of the account management system 102 with the assistance of the processing element 205 and operating system.

As indicated, in one embodiment, the account management system 102 may also include one or more network interfaces 220 for communicating with various computing entities (e.g., one or more client devices 104, one or more digital asset exchange systems 106), such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the account management system 102 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the account management system 102 may include, or be in communication with, one or more input elements, such as a keyboard input, a mouse input, a touch screen/display input, motion input, movement input, audio input, pointing device input, joystick input, keypad input, and/or the like. The account management system 102 may also include, or be in communication with, one or more output elements (not shown), such as audio output, video output, screen/display output, motion output, movement output, and/or the like.

As will be appreciated, one or more of the components of the account management system 102 may be located remotely from other components of the account management system 102, such as in a distributed system architecture. Furthermore, one or more of the components of the account management system 102 may be combined. Additional components performing functions, operations, methods, processes, and/or the like described herein may be included in the account management system 102. Thus, the account management system 102 may be adapted to accommodate a variety of needs and circumstances.

b. Exemplary Client Device

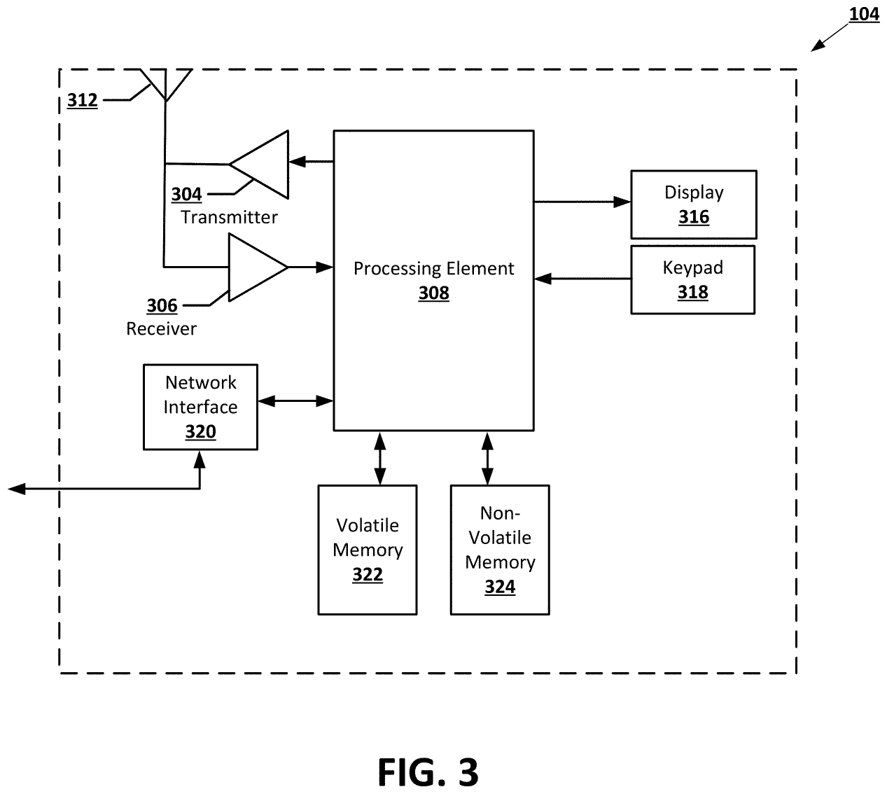

FIG. 3 provides a schematic of an example client device 104 that may be used in conjunction with embodiments of the present disclosure. Client devices 104 can be operated by various entities, and an example architecture 100 may include one or more client devices 104. For example, a client device 104 may be associated with, owned by, operated by, and/or the like by one or more end users. In various instances, an end user may operate an associated client device 104 to pre-configure or pre-select one or more digital assets as funding sources (e.g., to be converted in instances in which the end user possess insufficient fiat currency units to complete a merchant transaction). The end user may further operate an associated client device 104 to access and view various other user-specific data, account data (e.g., merchant transaction history, digital asset conversion history), and/or the like. In some embodiments, the end user may use payment means issued by an entity associated with the account management system 102 via the associated client device 104. For example, the end user may use the client device 104 to interact with a merchant device 108 (e.g., a point-of-sale device) for a merchant transaction.

A client device 104 may be a personal computing device, smartphone, tablet, laptop, personal digital assistant, and/or the like. As shown in FIG. 3, the client device 104 can include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the client device 104 may be capable of operating with one or more air interface standards, communication protocols, modulation types, and access types. More particularly, the client device 104 may operate in accordance with any of a number of wireless communication standards and protocols, such as those described above with regard to the account management system 102. In a particular embodiment, the client device 104 may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the client device 104 may operate in accordance with multiple wired communication standards and protocols, such as those described above with regard to the account management system 102 via a network interface 320.

Via these communication standards and protocols, the client device 104 can communicate with an account management system 102 using concepts, such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The client device 104 can also download changes, add-ons, and updates, for instance, to its firmware, software (e.g., including executable instructions, applications, program modules), and operating system.

According to one embodiment, the client device 104 may include location determining aspects, devices, modules, functionalities, and/or similar words used herein interchangeably. For example, the client device 104 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data can be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data can be determined by triangulating the position of the client device 104 in connection with a variety of other systems, including cellular towers, Wi-Fi access points, and/or the like. Similarly, the client device 104 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The client device 104 may also comprise a user interface (that can include a display 316 coupled to a processing element 308) and/or a user input interface (coupled to a processing element 308). For example, the user interface may be a user application, app, browser, user interface, and/or similar words used herein interchangeably executing on and/or accessible via the client device 104 to interact with and/or cause display of information/data from the account management system 102, as described herein. The user input interface can comprise any of a number of devices or interfaces allowing the client device 104 to receive data, such as a keypad 318 (hard or soft), a touch display, voice/speech or motion interfaces, or other input device. In embodiments including a keypad 318, the keypad 318 can include (or cause display of) the conventional numeric (0-9) and related keys (#, *), and other keys used for operating the client device 104 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The client device 104 can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the client device 104. As indicated, this may include a user application that is resident on the entity or accessible through a browser or other user interface for communicating with the account management system 102.

In another embodiment, the client device 104 may include one or more components or functionality that are the same or similar to those of the account management system 102, as described in greater detail above. As will be recognized, these architectures and descriptions are provided for exemplary purposes only and are not limiting to the various embodiments.

In various embodiments, the client device 104 may be embodied as an artificial intelligence (AI) computing entity, such as an Amazon Echo, Amazon Echo Dot, Amazon Show, Google Home, and/or the like. Accordingly, the client device 104 may be configured to provide and/or receive information/data from an end user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

c. Exemplary Digital Asset Exchange Systems

In various embodiments, an example architecture (e.g., the architecture 100 illustrated in FIG. 1) comprises one or more digital asset exchange systems 106. A digital asset exchange system 106 is an external system (e.g., external to the account management system 102 and/or the entity associated with the account management system 102) responsible for the management of an externally-custodied digital asset. As described, management of an externally-custodied digital asset by a digital asset exchange system 106 includes management of digital asset user accounts specific to the externally-custodied digital asset, execution of various debits and credits of the externally-custodied digital asset from and to the digital asset user accounts, configuration of various transaction (e.g., transfers, conversions, redemptions) conditions, thresholds, and limits, and/or the like.

Thus, a digital asset exchange system 106 is involved in the debiting of digital asset units for a digital asset conversion involving an externally-custodied digital asset. Accordingly, the architecture 100 may include one or more digital asset exchange systems 106 to thereby enable digital asset conversions for a variety of different digital assets. In some instances, one or more different externally-custodied digital assets are managed by a digital asset exchange system 106.

In various embodiments, a digital asset exchange system 106 may be a computing entity configured for engaging with an account management system 102 to debit and/or credit units of an externally-custodied digital asset for an end user. Specifically, a digital asset exchange system 106 is configured to manage a digital asset user account associated with the end user for a particular digital asset and to debit, deduct, withdraw, transfer, credit, deposit, and/or the like a number of digital asset units from and/or to the digital asset user account responsive to receiving a conversion execution API query originating from the account management system 102.

A digital asset exchange system 106 may be further responsible for executing and/or participating in fiat currency transactions with the account management system 102 and/or the entity associated with the account management system 102. For example, a digital asset conversion involves a debit of digital asset units, which is settled by a credit of fiat currency units. Thus, the digital asset exchange system 106 is configured to transfer fiat currency units to a fiat currency account associated with the account management system 102 and/or the entity associated with the account management system 102 (e.g., a fiat currency central operating account).

Various entities may be associated with and/or operate a digital asset exchange system 106. For example, a digital asset exchange system 106 may be associated with a liability digital asset that may be loyalty or reward points, and the digital asset exchange system 106 may be operated by or associated with a liability holder entity distributing and/or accepting the loyalty or reward points, such as a vendor entity, merchant entity, a service provider entity, a banking institution entity, a credit card manager entity, and/or the like. In some instances, a digital asset exchange system 106 associated with a liability digital asset and a liability holder entity may be operated by a third-party entity on behalf of the liability holder entity and/or the liability holder entity itself. Thus, the digital asset exchange system 106 may be and/or comprise one or more computing entities associated with the liability holder entity and may maintain digital asset user accounts (each associated with liability digital assets) for end users corresponding to the liability holder entity. As such, the digital asset exchange system 106 may store and/or have access to records of transactions made by end users with the liability holders that resulted in the assignment or crediting of liability digital asset units to the end users at a previous point in time.

Meanwhile, a digital asset exchange system 106 involved in the conversion of cryptocurrency digital assets may be associated with and/or operated by banking institution entities, monetary exchange entities, cryptocurrency exchange entities, stock exchange entities, trading platform entities, and/or the like and may be configured to communicate with and/or may comprise a distributed ledger computing platform. Further, a digital asset exchange system 106 may be associated with and/or operating by an auctioning platform entity, an asset holding entity, and/or the like. For example, such a digital asset exchange system 106 may be involved in the conversion (e.g., sale) of a NFT by an end user.

In managing an externally-custodied digital asset, a digital asset exchange system 106 is configured to generate, establish, configure, and/or communicate conversion conditions, thresholds, and limits for the externally-custodied digital asset. These conversion conditions, thresholds, and limits constrain the execution of various digital asset conversions for the externally-custodied digital asset and enable an entity managing the externally-custodied digital asset to maintain economic control over the externally-custodied digital asset. For example, an entity managing the externally-custodied digital asset configures various conversion conditions, thresholds, and limits to control the supply and demand for the externally-custodied digital asset and to manipulate the value of the externally-custodied digital asset. Such conversion conditions, thresholds, and limits include a total number of digital asset units that can be converted within a time period, a limit of digital asset units that can be converted by a particular end user, a limit of digital asset units that can be converted by a behavioral cohort of end users, a number of digital asset conversions that can be executed, and/or the like. These conversion conditions, thresholds, and limits are configured using a digital asset exchange system 106, and the digital asset exchange system 106 communicates and indicates such conversion conditions, thresholds, and limits to the account management system 102, such that the account management system 102 does not proceed with execution of a digital asset conversion that does not satisfy or that violates one or more conversion conditions, thresholds, and limits.

Thus, a digital asset exchange system 106 may comprise various means for performing at least the herein described functions, operations, methods, processes and/or the like. For example, a digital asset exchange system 106 may comprise various processing elements, volatile and/or non-volatile memory or memory media, network interfaces, user interfaces, and/or the like—including those described with regard to the account management systems 102 and/or client devices 104.

d. Exemplary Merchant Devices

In various embodiments, a merchant device 108 is a computing device associated with and operated by a merchant offering goods or services for purchase (e.g., in a merchant transaction). For example, a merchant device 108 may be a point-of-sale device, a computer, a laptop, a workstation, a smartphone, a merchant server, and/or the like configured to enable customers to purchase goods or services from the merchant at the cost of fiat currency units. A merchant device 108 may accordingly store merchant transaction data, such as the goods or services purchased in a merchant transaction, the cost of said goods or services, and/or the like. In particular, a merchant device 108 is configured to accept some payment means of a customer for the purchase of goods or services in a merchant transaction.

In various embodiments, the merchant device 108 requests authorization of the use of payments means from a customer from the issuing entity associated with the payments means. For example, a customer uses a debit card to pay for some goods or services, and the merchant device 108 request authorization for the payment from the entity that issues the debit card and that manages a fiat currency user account associated with the debit card. Thus, the merchant device 108 is configured to, and/or is in communication with a device configured to interface with payments means to register, initiate, and/or the like a merchant transaction. Specifically, the merchant device 108 is configured to generate and transmit an authorization request data object describing the merchant transaction to the issuing entity, or a system associated with and/or operated by the issuing entity (e.g., the account management system 102). In generating and transmitting the authorization request data object, the merchant device 108 is configured to capture information relating to the customer, such as the customer name, a card number, billing information, and/or the like. The authorization request data object accordingly identifies the customer involved in the merchant transaction. The merchant device 108 may be further configured to receive an authorization response data object or a denial response data object from the issuing entity or a system associated therewith (e.g., the account management system 102) indicating whether the merchant transaction is authorized or declined, respectively.

e. Exemplary Networks

In one embodiment, any two or more of the illustrative components of the architecture of FIG. 1 (e.g., one or more account management systems 102, one or more client devices 104, one or more digital asset exchange systems 106, one or more merchant devices 108) may be configured to communicate with one another via respective communicative couplings to one or more networks 120. The networks 120 may include, but are not limited to, any one or a combination of different types of suitable communications networks such as, for example, cable networks, public networks (e.g., the Internet), private networks (e.g., frame-relay networks), wireless networks, cellular networks, telephone networks (e.g., a public switched telephone network), or any other suitable private and/or public networks. Further, the networks 120 may have any suitable communication range associated therewith and may include, for example, global networks (e.g., the Internet), MANs, WANs, LANs, or PANs. In addition, the networks 120 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof, as well as a variety of network devices and computing platforms provided by network providers or other entities.

### V. Exemplary System Operation

Various embodiments of the present disclosure include various functions, steps, operations, methods, processes, and/or the like that may (or may be performed to) address technical challenges generally related to funding merchant transactions involving end users. In particular various embodiments provide technical solutions to such challenges by processing and executing digital asset conversions in real-time to fund a merchant transaction for an end user. In various embodiments, one or more digital assets, which may be pre-configured or pre-selected by the end user, are immediately converted to fiat currency units to result in the end user possessing a sufficient amount of fiat currency units for the merchant transaction, and the merchant transaction may then be accordingly authorized. Execution of a digital asset conversion involves the debit of digital asset units from a digital asset user account associated with the end user and the credit of fiat currency units to a fiat currency user account associated with the end user. In various embodiments, internally-custodied digital assets and/or externally-custodied digital assets may be converted for real-time funding of a merchant transaction.

Throughout at least the above, various embodiments provide technical advantages that include the reduction of overall system load, required user interactions, processing time and resources, and network communication. Various embodiments further improve security, accuracy, and efficiency in management of end user data relating to digital assets, such as user account data. Overall efficiency is achieved in various embodiments due in part to pre-configuration and pre-selection of particular digital assets as funding sources, such that appropriate digital asset conversions may be executed immediately and in real-time for the rapid authorization of merchant transactions.

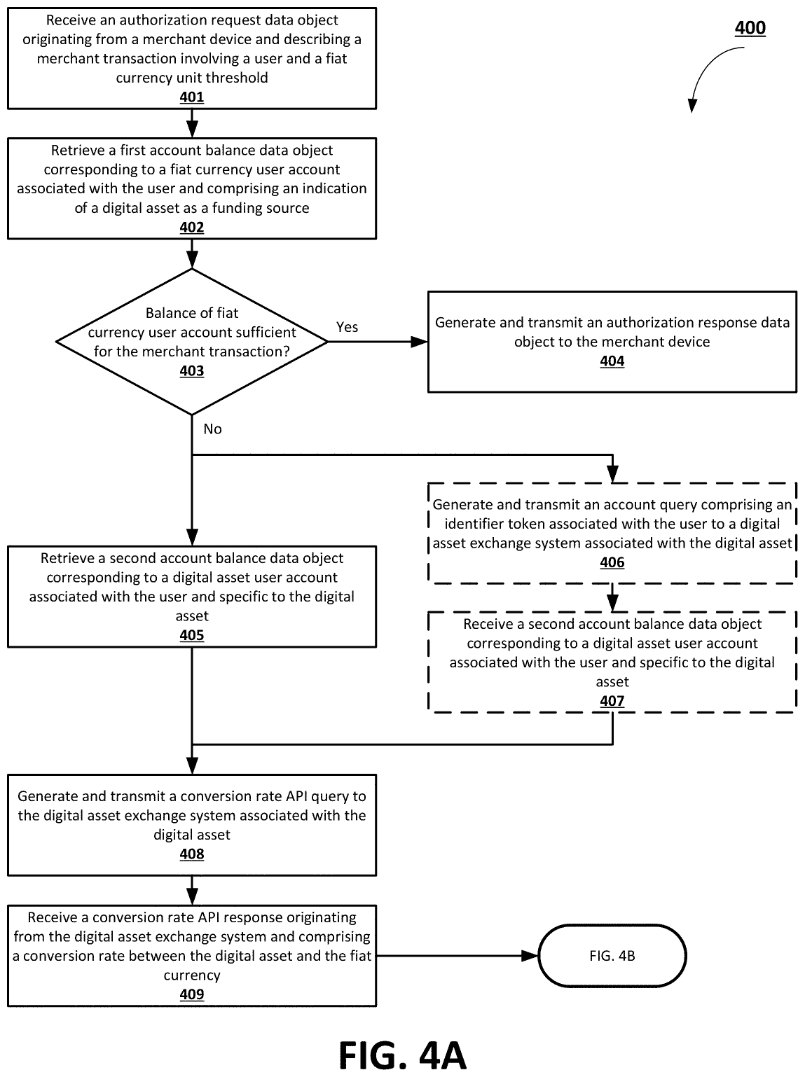

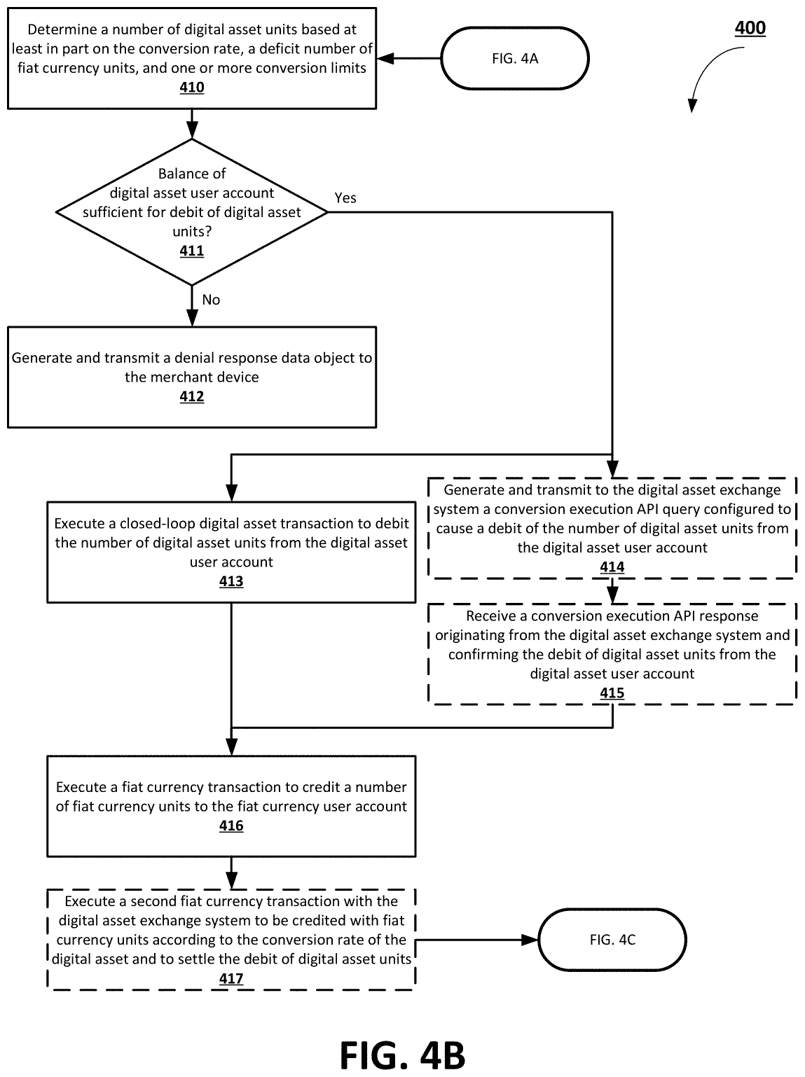

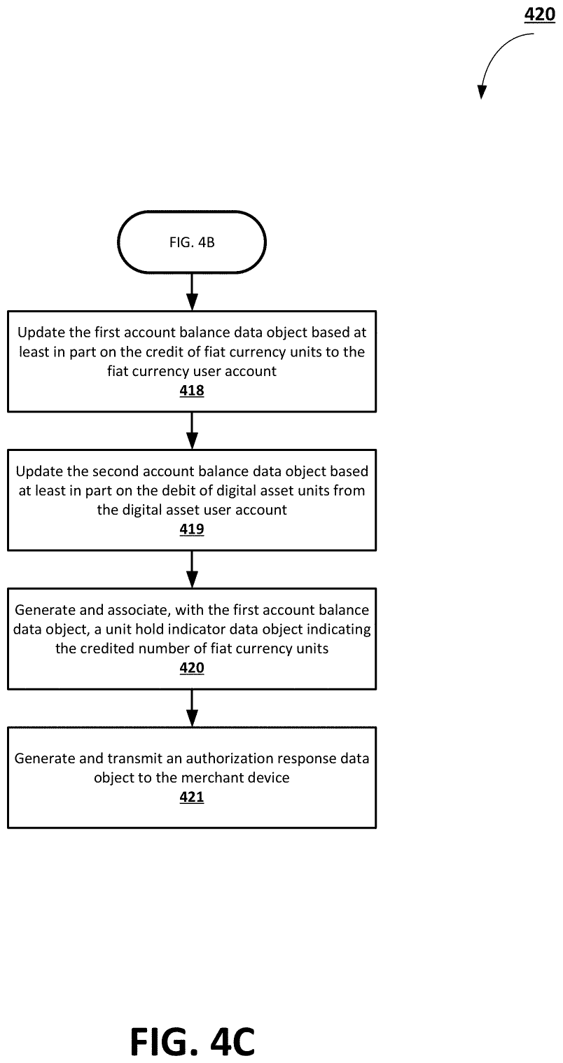

FIGS. 4A-C illustrate a process 400 for processing and executing digital asset conversions for real-time funding of a merchant transaction involving an end user. Process 400 comprises steps/operations for processing and executing digital asset conversions of internally-custodied digital assets and for processing and executing digital asset conversions of externally-custodied digital assets. In various embodiments, the account management system 102 comprises means, such as processing element 205, memories 210, 215, network interface 220, and/or the like, for performing each of the steps/operations of process 400 to process and to execute digital asset conversions (e.g., of internally-custodied digital assets, of externally-custodied digital assets) for real-time funding of the merchant transaction involving the end user.

Referring first to FIG. 4A, process 400 comprises step/operation 401. In one embodiment, process 400 begins with and is triggered by step/operation 401. Step/operation 401 comprises receiving an authorization request data object originating from a merchant device 108. The authorization request data object describes a merchant transaction involving an end user and a fiat currency unit threshold. For example, the fiat currency unit threshold reflects the number of fiat currency units owed by the end user to the merchant and may be based at least in part on the price of the goods or services, taxes and/or fees applicable to the merchant transaction, and/or the like.

In various embodiments, the authorization request data object is generated by the merchant device 108 associated with the merchant involved in the merchant transaction responsive to the end user providing payment means to the merchant. For example, the end user provides a debit card, a cash card, a credit card, and/or the like to the merchant as payment means for the merchant transaction, and the merchant generates, via the merchant device 108, the authorization request data object. The merchant transmits, via the merchant device 108, the authorization request data object to an entity that issued the payment means to the end user and managing a fiat currency user account linked to the payment means. In various embodiments, the entity issuing the payment means is the entity associated with and operating the account management system 102, and as such, the authorization request data object is provided to the account management system 102.

The authorization request data object then embodies a request for the entity to authorize the merchant transaction if the end user possesses a sufficient number of fiat currency units for the merchant transaction and to decline the merchant transaction if the end user does not possess a sufficient number of fiat currency units for the merchant transaction. Specifically, the merchant transaction can be authorized if a balance of the fiat currency user account satisfies the fiat currency unit threshold of the merchant transaction and can be declined if the balance of the fiat currency user account does not satisfy the fiat currency unit threshold. In various embodiments, the merchant is unaware of whether digital asset conversions are executed to result in the balance of the fiat currency user account satisfying the fiat currency unit threshold.

Step/operation 402 comprises retrieving a first account balance data object corresponding to the fiat currency user account associated with the user and linked to the payment means provided by the end user for the merchant transaction. In various embodiments, the first account balance data object is stored in memory accessible by the account management system 102, such as in memory 210, 215. In various embodiments, the account management system 102 retrieves the first account balance data object from a database configured to securely store a plurality of account balance data objects corresponding to a plurality of fiat currency user accounts and in communication with the account management system 102. The account management system 102 may be responsible for managing account balance data objects corresponding to fiat currency user accounts for a population of end users and accordingly is configured to (e.g., with permission configurations) access, read, write, generate, delete, and/or the like the first account balance data object.

In various embodiments, the first account balance data object is identified for retrieval based at least in part on mapping the end user (and identifiers thereof) described by the authorization request data object to an identifier token associated with the end user and configured to identify fiat currency user accounts and digital asset user accounts associated with the end user. The identifier token may reference the first account balance data object, thereby allowing efficient retrieval of account data associated with the end user identified by the identifier token.

The first account balance data object comprises one or more indications of one or more digital assets that are funding sources for the fiat currency user account. For example, the first account balance data object indicates that Bitcoin (BTC) and Ethereum can be converted to fiat currency to fund the fiat currency user account as needed. Different account balance data objects corresponding to different fiat currency user accounts may comprise different funding sources. Each digital asset indicated by the first account balance data object is associated with a precedence value that describes a sequential order or priority with which to convert the digital assets. In the earlier example, BTC is associated with a first precedence value and Ethereum is associated with a second precedence value, such that when necessary, BTC is converted first to the extent necessary to satisfy the fiat currency unit threshold of the merchant transaction. Ethereum is then converted only if enough BTC units cannot be converted to result in the balance of the fiat currency user account satisfying the fiat currency unit threshold.

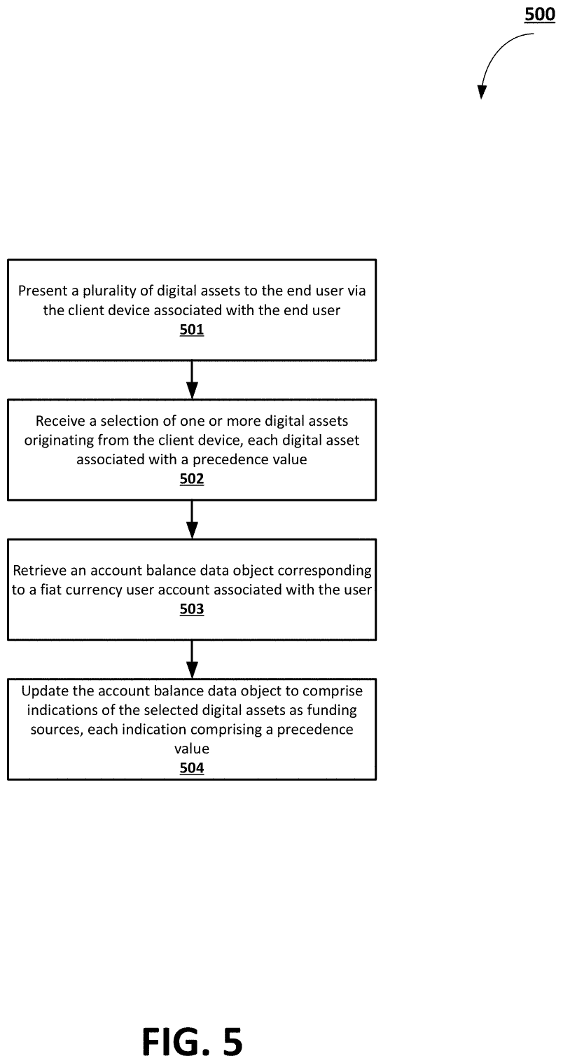

To enable rapid and efficient authorizations (or denials) of merchant transactions, the indications of digital assets as funding sources are pre-configured or pre-selected. As such, user interaction to select a particular digital asset to convert at the time of the merchant transaction becomes unnecessary. Referring now to FIG. 5, a process 500 is provided for pre-configuring or pre-selecting digital assets as funding sources. In various embodiments, process 500 is performed at some time prior to the merchant transaction. In various embodiments, the account management system 102 comprises means, such as processing element 205, memories 210, 215, network interface 220, and/or the like, for performing each of the steps/operations of process 500 to enable an end user to pre-configure or pre-select digital assets as funding sources.

At step/operation 501, a plurality of digital assets is presented to the end user via the client device 104 associated with the end user. Each digital asset is a digital asset that can be converted to fiat currency, and with the presentation, the end user is prompted to select one or more digital assets to use funding sources for a fiat currency user account.

At step/operation 502, a selection of one or more digital assets is received originating from the client device 104. In the selection, the one or more digital assets are associated with a precedence value. For example, the end user may, via a user interface, designate a sequential order or a priority with which to use the one or more digital assets as funding sources.

At step/operation 503, an account balance data object corresponding to the fiat currency user account is retrieved. As previously discussed, the account balance data object may be retrieved from memory, a secure database configured to store account balance data objects, and/or the like. Step/operation 504 then comprises updating the account balance data object to comprise indications of the selected digital assets as funding sources, with each indication comprising a precedence value of a corresponding digital asset.

Returning to FIG. 4A, step/operation 403 comprises determining whether the balance of the fiat currency user account linked to the payment means used in the merchant transaction is sufficient for the merchant transaction. If the balance of the fiat currency user account is sufficient, the merchant transaction can be authorized. As such, step/operation 404 is performed to generate and transmit an authorization response data object to the merchant device 108.

Otherwise, various embodiments proceed to execute digital asset conversions to supplement the insufficient balance of the fiat currency user account, with the digital asset conversions involving the credit of fiat currency units to the fiat currency user account. Thus, execution of digital asset conversions can result in the balance of the fiat currency user account becoming sufficient for the merchant transaction such that the merchant transaction can be authorized. It may be appreciated then that a denial response data object is not immediately transmitted to the merchant device 108, as the insufficient balance can be remedied via digital asset conversions.

To proceed with the execution of a digital asset conversion, account data relating to a digital asset user account specific to a pre-configured or pre-selected digital asset is obtained. For a digital asset that is an internally-custodied digital asset, step/operation 405 is performed to retrieve a second account balance data object that corresponds to a digital asset user account associated with the user and specific to the internally-custodied digital asset. Similar to the first account balance data object corresponding to the fiat currency user account the second account balance data object may be retrieved from memory (e.g., memories 210, 215) or from a database configured to store account balance data objects corresponding to digital asset user accounts specific to the internally-custodied digital asset. In any regard, the account management system 102 is configured to access and retrieve account balance data objects corresponding to digital asset user accounts specific to the internally-custodied digital asset, as the account management system 102 is configured to manage the internally-custodied digital asset.

The second account balance data object comprises and/or is associated with conversion limits configured by the account management system 102, as the account management system 102 is responsible for managing the internally-custodied digital asset and digital asset user accounts thereof. Such transfer conditions, thresholds, and limits that are specifically associated with the second account balance data object include individual and/or cohort-based conversion conditions. For example, the account management system 102 may have imposed a limit of five digital asset conversions per day for the end user, which is indicated by the second account balance data object corresponding to the digital asset user account associated with the end user. As another example, the account management system 102 may have imposed a general conversion limit for all end users that a maximum of one-hundred digital asset units can be converted during a digital asset conversion. Thus, retrieving an account balance data object corresponding to a digital asset user account comprises retrieving conversion limits associated with the end user and/or the digital asset user account associated with the end user.

For a digital asset that is an externally-custodied digital asset, step/operation 406 and step/operation 407 are performed. Step/operation 406 comprises generating and transmitting an account query comprising the identifier token associated with the end user to a digital asset exchange system 106 associated with the externally-custodied digital asset. In various embodiments, the account query is an API query structured and configured to be received by digital asset exchange system 106 at an API and to cause the digital asset exchange system 106 to respond with the second account balance data object corresponding to a digital asset user account associated with the user and specific to the externally-custodied digital asset. Accordingly, step/operation 407 comprises receiving a second account balance data object corresponding to the digital asset user account associated with the user and specific to the externally-custodied digital asset.

In various embodiments, the second account balance data object received originating from the digital asset exchange system 106 and specific to the externally-custodied digital asset is received with, are associated with, comprise, and/or the like conversion limits configured by the digital asset exchange system 106. As the externally-custodied digital asset is managed via the digital asset exchange system 106, the digital asset exchange system 106 may impose various conversion limits that are received by the account management system 102 with the account balance data objects. For example, the digital asset exchange system 106 provides the second account balance data object corresponding to the digital asset user account associated with the end user with the limit that a maximum of sixty digital asset units may be converted within the span of a day. A conversion limit may indicate discrete numbers of digital asset units that may be converted. For example, a conversion limit indicates that only ten, twenty, fifty, or one-hundred digital asset units may be converted.

Thus, a second account balance data object corresponding to a digital asset user account associated with the user and specific to a digital asset indicated as a funding source is retrieved if the digital asset is an internally-custodied digital asset or is receiving from a digital asset exchange system 106 if the digital asset is an externally-custodied digital asset. Step/operation 408 may then be performed to generate and transmit a conversion rate API query to a digital asset exchange system 106. In instances in which the digital asset is an internally-custodied digital asset, the digital asset exchange system 106 associated with the digital asset may be a system configured to determine a value and pricing data (e.g., conversion rates) for the digital asset. For example, while BTC may be an internally-custodied digital asset in a closed-loop environment managed by the account management system 102, a digital asset exchange system 106 external to the closed-loop environment may be associated with a distributed ledger for BTC and determine a value or worth of BTC that may still be applicable within the closed-loop environment.

The conversion rate API query is then configured to cause the digital asset exchange system 106 to respond with a conversion rate for the digital asset. For some digital assets, the digital asset exchange system 106 determines a conversion rate for the digital asset based at least in part on the end user and/or a cohort including the end user. For example, a business entity distributing loyalty point digital assets may offer a first conversion rate for important or high-status customers, while offering a second conversion rate for general customers. Accordingly, the conversion rate API query comprises the identifier token associated with the end user to identify the end user for the digital asset exchange system 106. The identifier token is federated, globally-unique, universally-unique, and/or the like, such that the identifier token is recognizable to the digital asset exchange system 106 and the end user may be identified. The conversion rate API query may further comprise a behavioral data object describing behavioral data of the end user and/or a behavioral cohort including the recipient, and the digital asset exchange system 106 is configured to use the behavioral data object with one or more predictive models, optimization models, machine learning models, and/or the like to determine a conversion rate for the end user.

Step/operation 409 then comprises receiving a conversion rate API response originating from the digital asset exchange system 106 and comprising a conversion rate between the digital asset and the fiat currency. For example, the conversion rate indicates that five units of the digital asset is worth USD $10. In various embodiments, the conversion rate API response comprises one or more rate-specific constraints associated with the conversion rate that constrain use of the conversion rate in a digital asset conversion. An example rate-specific constraint may be a maximum limit of two-hundred units of the digital asset that may be converted to the fiat currency at the conversion rate of five units to USD $10. Various rate-specific constraints may be individual and/or cohort-based.

Thus, a conversion rate is determined for the digital asset in preparation for executing a digital asset conversion for the digital asset. Process 400 continues in FIG. 4B. As illustrated in FIG. 4B, step/operation 410 comprises determining a number of digital asset units to debit for the digital asset conversion. In various embodiments, the number of digital asset units to debit is determined based at least in part on the conversion rate between the digital asset and the fiat currency; the balance of the fiat currency user account; the fiat currency unit threshold for the merchant transaction; various conversion limits associated with the end user, the digital asset, or the conversion rate; and/or the like. For example, it is determined that five digital asset units should be debited when the merchant transaction involves USD $50 and the balance of the fiat currency user account is USD $40, assuming a conversion rate of five digital asset units to USD $10.

At step/operation 411, it is determined whether the balance of the digital asset user account specific to the digital asset is sufficient for the determined number of digital asset units. In the previous example, the end user may or may not possess the five digital asset units that would supplement the balance of the fiat currency user account to be sufficient for the merchant transaction. This determination is made using the second account balance data object corresponding to the digital asset user account that is retrieved or received.

Here, it may further be determined whether additional digital asset conversions are required. Additional digital asset conversions would be required if enough digital asset units cannot be converted to supplement the balance of the fiat currency user account. In various instances, this deficiency of digital asset units arises due to conversion limits (e.g., for the end user, for the digital asset) and/or the balance of the digital asset user account. In the previous example, a conversion limit may constrain the digital asset conversion to two digital asset units, thus, the debit of five digital asset units to credit USD $10 cannot be executed. Similarly, the balance of the digital asset user account may be four digital asset units, so five digital asset units cannot be debited from the digital asset user account. In such instances, additional digital asset conversions may be determined to be necessary (in addition to the described digital asset conversion) for the real-time funding of the merchant transaction. Accordingly, in an illustrative example, the balance of the fiat currency user account of USD $40 is supplemented with USD $7 from converting a first digital asset and with USD $3 from converting a second digital asset to fulfill a merchant transaction of USD $50.

If additional digital asset conversions are determined to be necessary, at least some of steps/operations 405-411 are performed for each additional digital asset to be converted. As previously discussed, additional digital assets are determined according to the precedence value associated with each digital asset pre-configured or pre-selected by the end user.

In various instances, digital asset conversions for each and every digital asset pre-configured or pre-selected by the end user are defined by performing steps/operations 405-411, and the balance of the fiat currency user account remains insufficient for the merchant transaction. For example, it may be determined through steps/operations 405-411 that a maximum of USD $8 can be obtained through converting each and every digital asset pre-configured or pre-selected by the end user, and as such, the balance of the fiat currency user account of USD $40 cannot be supplemented to be sufficient for a merchant transaction of USD $50. In such instances, step/operation 412 may be performed. Step/operation 412 comprises generating and transmitting a denial response data object to the merchant device 108 in response to the authorization request data object (e.g., received in step/operation 401). The denial response data object may indicate to the merchant that the end user, or customer, does not possess a sufficient number of fiat currency units to complete the merchant transaction, and the merchant transaction may be accordingly canceled.

Otherwise, if digital asset conversions can be executed to fully supplement the balance of the fiat currency user account to sufficiency for the merchant transaction, the digital asset conversions are executed. For a digital asset conversion of an internally-custodied digital asset, step/operation 413 is performed. Step/operation 413 comprises executing a closed-loop digital asset transaction to debit digital asset units from the digital asset user account, or executing a closed-loop debit. As the internally-custodied digital asset is managed within a closed-loop environment, the closed-loop debit may be a transfer of digital asset units from the digital asset user account to a central operating account (e.g., a reserve) of the closed-loop environment. The closed-loop debit specifically transfers the determined number of digital asset units out from the digital asset user account and into the central operating account.

In various instances when the internally-custodied digital asset is a cryptoasset or a cryptocurrency digital asset, the closed-loop debit is an off-chain transaction. The off-chain transaction is a transaction of a digital asset not recorded on a distributed ledger (e.g., a blockchain). As such, the off-chain transaction may be processed, agreed upon, verified, and/or the like by entities involved in the off-chain transaction (e.g., the account management system 102), but the off-chain transaction may be unknown to participants of the distributed ledger who are not involved in the off-chain transaction. An off-chain transaction may rely on external validation methods, as an off-chain transaction is not recorded on a distributed ledger and may not be verified or validated based at least in part on distributed ledger public key values and/or distributed ledger private key values.

Execution of the closed-loop debit comprises generation of a first transaction record data object, and the first transaction record data object describes the closed-loop debit from the end user. In managing the internally-custodied digital asset, the account management system 102 is configured to generate and store a plurality of transaction record data objects such that a comprehensive history of transactions within the closed-loop environment of the internally-custodied digital asset is maintained. In an example embodiment, the account management system 102 generates and stores the first transaction record data object in a database configured to store a plurality of transaction record data objects for the closed-loop environment of the internally-custodied digital asset.

The first transaction record data object describes aspects of the closed-loop transaction (e.g., the closed-loop debit) including the end user, the number of digital asset units debited, the time of the transaction, and/or the like. In various embodiments, the first transaction record data object comprises one or more identifiers for the end user, such as a name, a username, an identifying code or value, and/or the like, and/or the identifier token associated with the sender. The first transaction record data object may be associated with a record identifier or identifying value such that the first transaction record data object may be identified, located, retrieved, accessed, and/or the like at a future point in time.

In various embodiments, the account management system 102 executes an open-loop transaction based at least in part on the closed-loop debit from the digital asset user account. The account management system 102 is configured to monitor the balance of the central operating account of the closed-loop environment for the internally-custodied digital asset and determine whether various balance thresholds are satisfied. In some instances, the closed-loop debit may cause the balance of the central operating account to not satisfy (e.g., exceed) one or more balance thresholds, and the account management system 102 executes an open-loop transaction to manage the balance of the central operating account, such as by selling some number of digital asset units. In an example embodiment, the alternative digital asset is a cryptoasset or a cryptocurrency digital asset, and the open-loop transaction is an on-chain transaction involving the sale of units of the cryptoasset or a cryptocurrency digital asset by the account management system 102 and/or the entity associated with the account management system 102 in order to adequately manage the total supply of the closed loop environment for the cryptoasset or a cryptocurrency digital asset and the further obtain fiat currency units. The account management system 102 executes the on-chain transaction based at least in part on committing an on-chain transaction record data object to a distributed ledger (e.g., a blockchain) for the internally-custodied digital asset, the distributed ledger being external to the closed-loop environment. In various instances, multiple closed-loop debits may be executed (e.g., in an off-chain manner) within a short amount of time for multiple digital asset conversion, and the account management system 102 is configured to preemptively execute an open-loop transaction (e.g., on-chain transaction) based at least in part on projecting and predicting the balance of the central operating account using one or more predictive models, projection models, optimization models, machine learning models, and/or the like.

For a digital asset conversion of an externally-custodied digital asset, step/operation 414 and step/operation 415 are performed. Step/operation 414 comprises generating and transmitting a conversion execution API query to the digital asset exchange system 106. The conversion execution API query is configured to cause the digital asset exchange system 106 to debit the determined number of digital asset units from the digital asset user account associated with the end user. The conversion execution API query comprises the identifier token associated with the end user such that the digital asset exchange system 106 identifies the digital asset user account from which to debit digital asset units. Additionally or alternatively, the first transfer execution API query may comprise one or more identifiers (e.g., an account number, a username, an e-mail address, a routing number) associated with the first digital asset user account.

At step/operation 415, a conversion execution API response originating from the digital asset exchange system is received. The conversion execution API response confirms the debit of digital asset units from the digital asset user account. The conversion execution API response may comprise a transaction record data object describing the debit, such as the time of debit, the number of digital asset units debited, and the first digital asset user account.

Thus, digital asset units are debited from the end user during execution of the digital asset conversion, and the digital asset units may be debited via a closed-loop debit if the digital asset is an internally-custodied digital asset or via a conversion execution API query transmitted to a digital asset exchange system 106 if the digital asset is an externally-custodied digital asset. Execution of the digital asset conversion subsequently involves the credit of fiat currency units to the end user, or specifically to the fiat currency user account.

As such, step/operation 416 is performed to execute a fiat currency transaction to credit a number of fiat currency units to the fiat currency user account. The number of fiat currency units to credit is specifically based at least in part on the number of digital asset units debited and the conversion rate associated with the digital asset. Again, multiple digital asset conversions involving a debit of digital asset units and this credit of fiat currency units may be executed, in some instances, and the fiat currency user account is credited with fiat currency units to the extent that the balance of the fiat currency user account is sufficient for the merchant transaction.

The fiat currency units credited to the fiat currency user account specifically originate from the account management system 102 and/or the entity associated with and operating the account management system 102. As the entity associated with and operating the account management system 102 is also the entity that issued the payment means used by the end user and that manages the fiat currency user account, the credit of fiat currency units to the fiat currency user account is rapidly and efficiently processed, relative to a transfer of fiat currency units from some external entity. In particular, this credit of fiat currency units originating from the entity associated with and operating the account management system 102 is efficient when a digital asset conversion for an externally-custodied digital asset is executed, as a transfer of digital asset units originating from the digital asset exchange system 106 and/or an entity associated with the externally-custodied digital asset may take a significant amount of time to be processed.

In this regard, when a digital asset conversion for an externally-custodied digital asset is executed, step/operation 417 is performed. Step/operation 417 comprises executing a second fiat currency transaction with the digital asset exchange system 106 and/or an entity associated therewith. In the second fiat currency transaction, the entity associated with the account management system 102 is credited with fiat currency units to settle the debit of digital asset units from the end user, and the second fiat currency transaction occurs at some time subsequent to the credit of fiat currency units to the end user. Thus, the account management system 102 effectively sells the number of digital asset units on behalf of end user, credits the end user with a number of fiat currency units assumed to be received for the sale, and then subsequently receives the number of fiat currency units from the sale.

The second fiat currency transaction may be configured to settle more than one debit of digital asset units, in various embodiments. For example, the account management system 102 generates, updates, records, and/or the like a settlement record data object describing a plurality of debits with the digital asset exchange system 106 within a configurable time period (e.g., for a plurality of digital asset conversions). The account management system 102 is then paid in the second fiat currency transaction for the plurality of debits based at least in part on transmitting the settlement record data object to the digital asset exchange system 106. When executing one fiat currency transaction to settle a plurality of debits of digital asset units or a plurality of credits of digital asset units, various embodiments of the present disclosure advantageously reduce network bandwidth and network load.

In accordance with executing a digital asset conversion for real-time funding of a merchant transaction and specifically debiting digital asset units and crediting fiat currency units, the end user may be provided with a notification via the client device 104, the notification describing the execution of the digital asset conversion. The notification may describe which digital assets were converted for real-time funding (e.g., may be multiple digital assets in some instances), a number of digital asset units debited, a number of fiat currency units credited, a conversion rate at which the digital asset conversion(s) were executed, and/or the like.

Process 400 continues in FIG. 4C, which illustrates step/operation 418. Step/operation 418 comprises updating the first account balance data object corresponding to the fiat currency user account to reflect the credit of fiat currency units. In various embodiments, a transaction record data object is generated to describe the credit of fiat currency units, and the first account balance data object is updated to comprise and/or to be associated with the transaction record data object. In any regard, the first account balance data object is updated to reflect the balance of the fiat currency user account resulting from one or more credits of fiat currency units.

Similarly, one or more second account balance data objects are updated at step/operation 419. The second account balance data object(s) correspond to the digital asset user accounts involved in one or more digital asset conversions and are updated to reflect resulting balances of the digital asset user accounts from the debit(s) of digital asset units. Accordingly, the second account balance data object(s) may comprise transaction record data objects describing said debits.

At step/operation 420, a unit hold indicator data object is generated and associated with the first account balance data object corresponding to the fiat currency user account. The unit hold indicator data object is configured to designate and/or reserve a number of fiat currency units of the fiat currency user account for the merchant transaction (e.g., the fiat currency unit threshold). The unit hold indicator data object is configured to prevent other transactions from using the designated or reserved number of fiat currency units while the merchant transaction is being processed (e.g., by the merchant). Accordingly, the unit hold indicator data object may be removed upon completion of the merchant transaction.

At step/operation 421, an authorization response data object is then generated and transmitted to the merchant device 108, thereby fulfilling a response to the authorization request data object (e.g., received in step/operation 401). As the fiat currency user account now has a sufficient balance for the merchant transaction due to the execution of one or more digital asset conversions, the merchant transaction can be authorized.

Having thus described various functions, steps/operations, methods, processes, and/or the like for processing and executing digital asset conversions for real-time funding of a merchant transaction, additional embodiments are herein described in the context of various user interfaces. In various embodiments, the user interfaces provided and described in the present disclosure are configured to be provided via a client device 104 (e.g., via a display 316). In other embodiments, the user interfaces may be provided via the account management system 102, a digital asset exchange system 106, and/or other various systems or devices involved in the execution of digital asset conversions for real-time funding of merchant transactions.

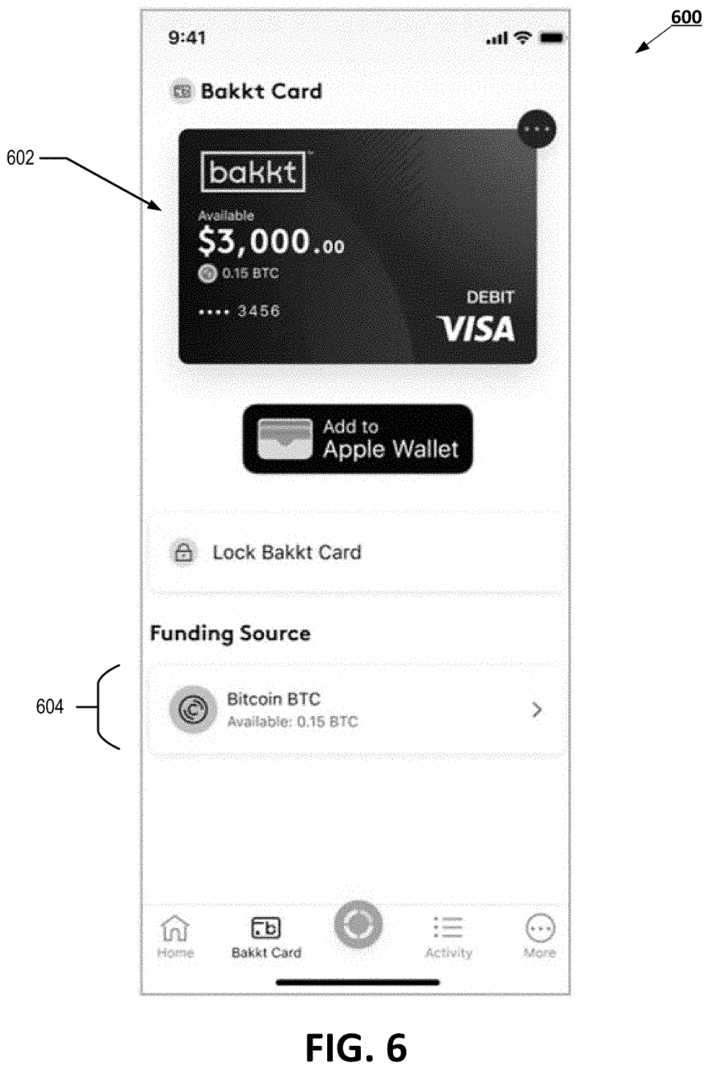

FIG. 6 illustrates a user interface 600 displaying a payment means 602 linked to a fiat currency user account and one or more digital assets as funding sources 604 for the payment means 602. In the illustrated embodiment, the payment means 602 is a debit card linked to a fiat currency user account, and BTC is a funding source 604 for the debit card and/or the fiat currency user account. Whenever the payment means 602 (e.g., the debit card) is used in merchant transactions and the balance of the fiat currency user account is insufficient, digital assets that are funding sources 604 (e.g., BTC) are converted to fund fiat currency to the fiat currency user account. In the illustrated embodiment, user interface 600 indicates a total available number of fiat currency units that may be obtained to fund a merchant transaction if needed from converting one of more funding sources 604. For instance, user interface 600 indicates that USD $3000 may be credited to the end user if needed if all 0.15 BTC units owned by the end user in a digital asset user account are converted to fiat currency.

Thus, generation of the user interface 600 may require knowledge of a current or real-time conversion rate for the digital asset that is a funding source 604 (e.g., a conversion rate of 0.15 BTC to USD $3000). In various embodiments, a conversion rate is determined based at least in part on generating and transmitting a conversion rate API query to a digital asset exchange system 106 associated with the digital asset. To provide accurate information to the end user via the user interface 600, conversion rate API queries are transmitted responsive to an automated timing trigger for a configurable time period. For example, a time period may be configured based at least in part on a volatility of the digital asset, such that conversion rates are obtained to accurately represent a real-time value or worth of the digital asset.

The end user is enabled to select one or more digital assets as funding sources 604 via a user interface, such as user interface 600. For example, the end user may additionally select Ethereum, a loyalty point digital asset, and/or the like in addition to BTC to use as a funding source 604. Further, the end user may designate a sequential order or a priority for each digital asset. For example, the end user may indicate that BTC should be converted first to the extent possible before converted a loyalty point digital asset. Thus, an end user may view information relating to real-time funding before participating in a merchant transaction, and the end user may further configure and select funding sources 604 for the real-time funding.

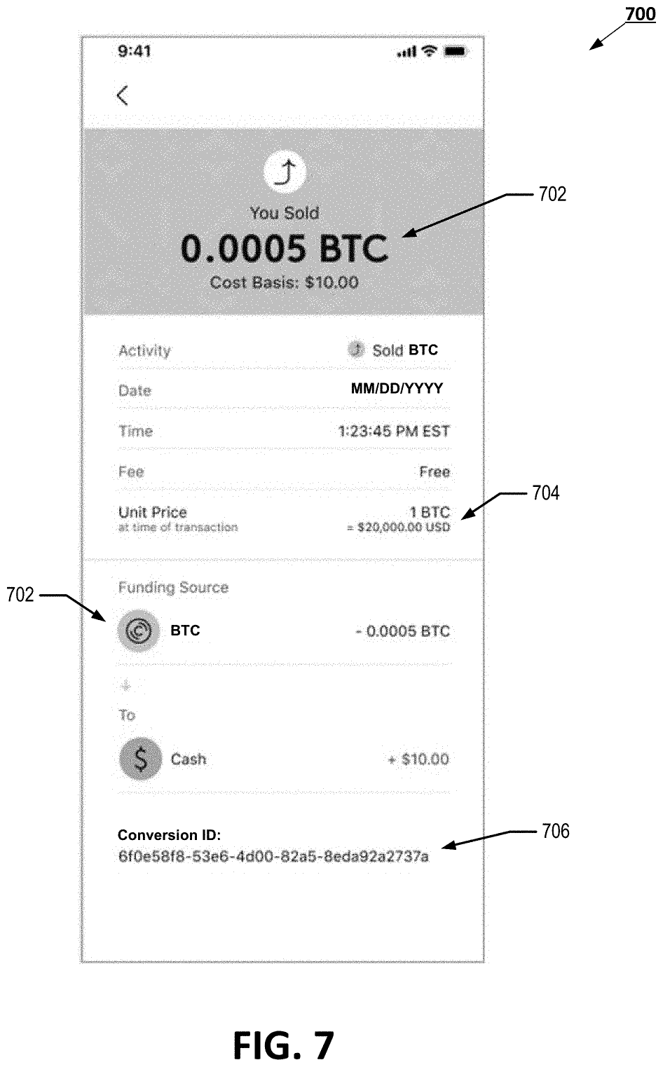

FIG. 7 illustrates a user interface 700 for notifying the end user of the execution of a digital asset conversion for real-time funding of a merchant transaction. The executed digital asset conversion is specifically for a digital asset pre-configured or pre-selected as a funding source 604 for a payment means 602. In the illustrated embodiment, the digital asset that is converted is BTC, as indicated as a funding source 604 in user interface 600. In notifying the end user of the execution of a digital asset conversion, user interface 700 indicates the digital asset 702 that is converted, as well as the conversion rate 704 at which the digital asset conversion was executed. For example, user interface 700 indicates that the conversion rate 704 at the time of execution was 1 BTC unit to USD $20,000. The user interface 700 provides additional details regarding the digital asset conversion, including the number of digital asset units debited (e.g., 0.0005 BTC units), the number of fiat currency units credited or received to supplement and fund the fiat currency user account (e.g., USD $10), the time at which the digital asset conversion was executed, and conversion identifier 706, and/or the like. The conversion identifier 706 is configured to uniquely identify the executed digital asset conversion and may be linked or connected to one or more transaction record data objects describing the debit of digital asset units (e.g., a closed-loop debit, a debit caused by transmitting a conversion execution API query) and/or the credit of fiat currency units.

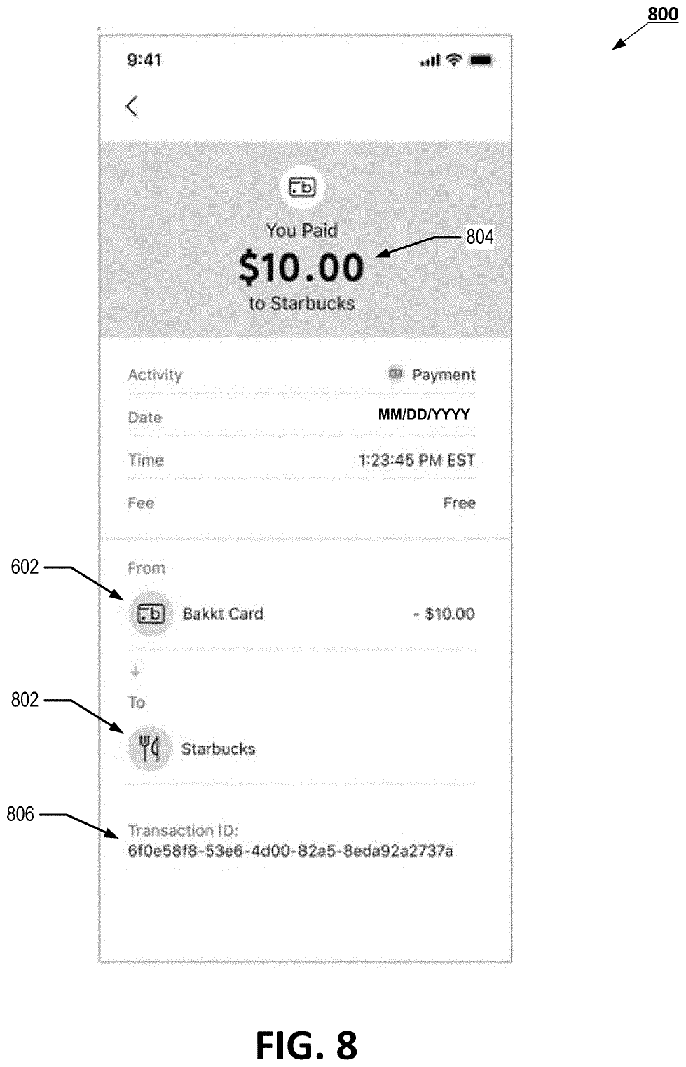

FIG. 8 illustrates a user interface 800 for describing a merchant transaction for which the end user used the payment means 602. As such, user interface 800 indicates the merchant involved in the merchant transaction, as well as the number of fiat currency units 802 paid by the end user via payment means 602 in the merchant transaction. In some embodiments, user interface 800 may indicate that at least a portion of the number of fiat currency units 802 paid (e.g., USD $10) originated from the execution of digital asset conversions for real-time funding, and the end user may obtain more information concerning the execution of said digital asset conversions via a user interface such as user interface 700. User interface 800 further indicates a transaction identifier 806 associated with the merchant transaction and use of payment means 602. The transaction identifier 806 may be used to identify, locate, retrieve, and/or the like one or more transaction record data objects describing the merchant transaction and the use of fiat currency units.

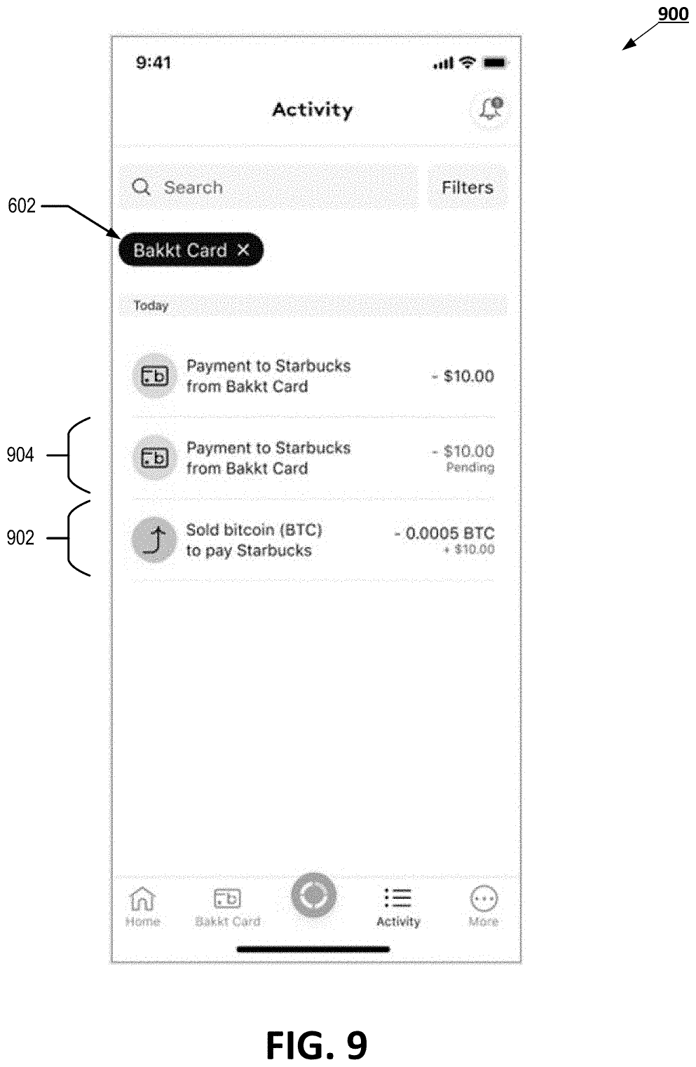

FIG. 9 illustrates a user interface 900 for providing an activity history associated with a payment means 602 and various funding sources 604 associated with the payment means 602. In the illustrated embodiment, the activity history describes a digital asset conversion 902 executed for real-time funding of the payment means 602 and the fiat currency user account associated therewith, as well as a merchant transaction 904 for which the payment means 602 was funded. As illustrated, 0.0005 BTC units were converted to USD $10, and the USD $10 were used for the merchant transaction. In various embodiments, the end user can search for specific transactions (e.g., merchant transactions 904) and digital asset conversions 902 in the activity history based at least in part on various criteria, such as the digital asset 702 converted in a digital asset conversion 902, the merchant involved in a merchant transaction 904, conversion identifiers 706, transaction identifier 806, and/or the like.

Accordingly, various embodiments of the present disclosure provide for efficient, accurate, and secure execution of digital asset conversions for real-time funding of a merchant transaction involving an end user. Efficiency is provided at least in part by pre-configuration and pre-selection of digital assets as funding sources, which additional reduces necessary user interactions and overall system load at the time of the merchant transaction. Efficiency is further provided during the execution of closed-loop digital asset transactions and the transmission of conversion execution API queries. Further efficiency is provided in part through the use of identifier tokens associated with end users that are federated, globally unique, and/or universally unique for a plurality of systems (e.g., account management system 102, digital asset exchange systems 106) for identifying end users and user accounts associated therewith. Meanwhile, digital asset conversions are accurately executed using current and real-time conversion rates for digital assets, which are efficiently determined using API communication.

### VI. Conclusion

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A computer-implemented method comprising:
receiving, using a processor, an authorization request data object originating from a merchant device, the authorization request data object describing a merchant transaction involving an end user and fiat currency unit threshold;
retrieving, using the processor, a first account balance data object corresponding to a fiat currency user account associated with the end user;
determining, using the processor and using the first account balance data object, whether a balance of the fiat currency user account satisfies the fiat currency unit threshold of the merchant transaction;
responsive to determining that the balance of the fiat currency user account does not satisfy the fiat currency unit threshold of the merchant transaction:
retrieving, using the processor, a second account balance data object corresponding to a digital asset user account associated with the end user and specific to a digital asset;
determining, using the processor, a conversion rate between the digital asset and a fiat currency;
executing, using the processor, a digital asset conversion comprising a closed-loop debit of a number of digital asset units from the digital asset user account and a credit of a number of fiat currency units to the fiat currency user account;
updating, using the processor, the first account balance data object according to the execution of the digital asset conversion; and
causing, using the processor, transmission of a response data object to the merchant device, the response data object comprising one of an authorization or a denial of the merchant transaction based at least in part on the balance of the fiat currency user account resulting from the digital asset conversion and described by the first account balance data object.

2. The computer-implemented method of claim 1, wherein determining the conversion rate between the digital asset and the fiat currency comprises:
causing transmission of a conversion rate API query indicating the digital asset and comprising an identifier token associated with the end user; and
receiving a conversion rate API response comprising a conversion rate between the digital asset and the fiat currency.

3. The computer-implemented method of claim 1, wherein executing the digital asset conversion comprises determining the number of digital asset units for the closed-loop debit based at least in part on the balance of the fiat currency user account, the fiat currency unit threshold of the merchant transaction, and the conversion rate between the digital asset and the fiat currency.

4. The computer-implemented method of claim 3, wherein the number of digital asset units for the closed-loop debit is determined further based at least in part on one or more conversion limits associated with the end user and/or the digital asset.

5. The computer-implemented method of claim 1, further comprising:
determining whether a resulting balance of the fiat currency user account subsequent to executing the digital asset conversion satisfies the fiat currency threshold of the merchant transaction; and
responsive to determining that the resulting balance does not satisfy the fiat currency threshold of the merchant transaction, executing a second digital asset conversion for a second digital asset comprising a closed-loop debit from a second digital asset user account associated with the end user and specific to the second digital asset, and a credit of a second number of fiat currency units to the fiat currency user account.

6. The computer-implemented method of claim 1, wherein the digital asset is one of a set of digital assets pre-selected by the end user, and each digital asset is associated with a precedence value indicating a priority with which to execute a digital asset conversion for a respective digital asset.

7. A system comprising one or more memory storage areas and one or more processors, the system configured for:
receiving an authorization request data object originating from a merchant device, the authorization request data object describing a merchant transaction involving an end user and fiat currency unit threshold;
retrieving a first account balance data object corresponding to a fiat currency user account associated with the end user;
determining, using the first account balance data object, whether a balance of the fiat currency user account satisfies the fiat currency unit threshold of the merchant transaction;
responsive to determining that the balance of the fiat currency user account does not satisfy the fiat currency unit threshold of the merchant transaction:
retrieving a second account balance data object corresponding to a digital asset user account associated with the end user and specific to a digital asset;
determining a conversion rate between the digital asset and a fiat currency;
executing a digital asset conversion comprising a closed-loop debit of a number of digital asset units from the digital asset user account and a credit of a number of fiat currency units to the fiat currency user account;
updating the first account balance data object according to the execution of the digital asset conversion; and
causing transmission of a response data object to the merchant device, the response data object comprising one of an authorization or a denial of the merchant transaction based at least in part on the balance of the fiat currency user account resulting from the digital asset conversion and described by the first account balance data object.

8. The system of claim 7, wherein determining the conversion rate between the digital asset and the fiat currency comprises:
causing transmission of a conversion rate API query indicating the digital asset and comprising an identifier token associated with the end user; and
receiving a conversion rate API response comprising a conversion rate between the digital asset and the fiat currency.

9. The system of claim 7, wherein executing the digital asset conversion comprises determining the number of digital asset units for the closed-loop debit based at least in part on the balance of the fiat currency user account, the fiat currency unit threshold of the merchant transaction, and the conversion rate between the digital asset and the fiat currency.

10. The system of claim 9, wherein the number of digital asset units for the closed-loop debit is determined further based at least in part on one or more conversion limits associated with the end user and/or the digital asset.

11. The system of claim 7, further configured for:
determining whether a resulting balance of the fiat currency user account subsequent to executing the digital asset conversion satisfies the fiat currency threshold of the merchant transaction; and
responsive to determining that the resulting balance does not satisfy the fiat currency threshold of the merchant transaction, executing a second digital asset conversion for a second digital asset comprising a closed-loop debit from a second digital asset user account associated with the end user and specific to the second digital asset, and a credit of a second number of fiat currency units to the fiat currency user account.

12. The system of claim 7, wherein the digital asset is one of a set of digital assets pre-selected by the end user, and each digital asset is associated with a precedence value indicating a priority with which to execute a digital asset conversion for a respective digital asset.

13. A computer program product comprising at least one non-transitory computer-readable storage medium having computer-readable program code portions stored therein, the computer-readable program code portions comprising executable portions configured for:
receiving an authorization request data object originating from a merchant device, the authorization request data object describing a merchant transaction involving an end user and fiat currency unit threshold;
retrieving a first account balance data object corresponding to a fiat currency user account associated with the end user;
determining, using the first account balance data object, whether a balance of the fiat currency user account satisfies the fiat currency unit threshold of the merchant transaction;
responsive to determining that the balance of the fiat currency user account does not satisfy the fiat currency unit threshold of the merchant transaction:
retrieving a second account balance data object corresponding to a digital asset user account associated with the end user and specific to a digital asset;
determining a conversion rate between the digital asset and a fiat currency;
executing a digital asset conversion comprising a closed-loop debit of a number of digital asset units from the digital asset user account and a credit of a number of fiat currency units to the fiat currency user account;
updating the first account balance data object according to the execution of the digital asset conversion; and
causing transmission of a response data object to the merchant device, the response data object comprising one of an authorization or a denial of the merchant transaction based at least in part on the balance of the fiat currency user account resulting from the digital asset conversion and described by the first account balance data object.

14. The computer program product of claim 13, wherein determining the conversion rate between the digital asset and the fiat currency comprises:
causing transmission of a conversion rate API query indicating the digital asset and comprising an identifier token associated with the end user; and
receiving a conversion rate API response comprising a conversion rate between the digital asset and the fiat currency.

15. The computer program product of claim 13, wherein executing the digital asset conversion comprises determining the number of digital asset units for the closed-loop debit based at least in part on the balance of the fiat currency user account, the fiat currency unit threshold of the merchant transaction, and the conversion rate between the digital asset and the fiat currency.

16. The computer program product of claim 15, wherein the number of digital asset units for the closed-loop debit is determined further based at least in part on one or more conversion limits associated with the end user and/or the digital asset.

17. The computer program product of claim 13, wherein the computer-readable program code portions comprise executable portions further configured for:
determining whether a resulting balance of the fiat currency user account subsequent to executing the digital asset conversion satisfies the fiat currency threshold of the merchant transaction; and
responsive to determining that the resulting balance does not satisfy the fiat currency threshold of the merchant transaction, executing a second digital asset conversion for a second digital asset comprising a closed-loop debit from a second digital asset user account associated with the end user and specific to the second digital asset, and a credit of a second number of fiat currency units to the fiat currency user account.

18. The computer program product of claim 13, wherein the digital asset is one of a set of digital assets pre-selected by the end user, and each digital asset is associated with a precedence value indicating a priority with which to execute a digital asset conversion for a respective digital asset.
